(19) United States
(12) Patent Application Publication
(10) Pub. No.: US 2026/0163777 A1
(43) Pub. Date: Jun. 11, 2026

(54) DMRS FOR PDCCH

(71) Applicant: QUALCOMM Incorporated, San Diego, CA (US)

(72) Inventors: Weimin DUAN, San Diego, CA (US); Le LIU, San Jose, CA (US); Jing JIANG, San Diego, CA (US); Diana MAAMARI, San Diego, CA (US); Gabi SARKIS, San Diego, CA (US); Kangqi LIU, San Diego, CA (US); Huilin XU, Temecula, CA (US); Mostafa KHOSHNEVISAN, San Diego, CA (US)

(21) Appl. No.: 18/972,695

(22) Filed: Dec. 6, 2024

(51) Int. Cl. H04L 27/26; H04W 72/23

(52) U.S. Cl. CPC H04L 27/261; H04W 72/23

(57) ABSTRACT

A method for wireless communication at a user equipment (UE) and related apparatus are provided. In the method, the UE receives a configuration for a control resource set (CORESET) and monitors for a physical downlink control channel (PDCCH) transmission in the CORESET. The CORESET spans multiple symbols. A first number of demodulation reference signal (DMRS) transmissions in a first symbol of the multiple symbols is higher than a second number of DMRS transmissions in any symbol of the remaining symbols in the multiple OFDM symbols, and the DMRS density in the first symbol is based on the number of symbols in the multiple OFDM symbols or the minimum aggregation level for the DMRS transmissions.

### TECHNICAL FIELD

The present disclosure relates generally to communication systems and, more particularly, to the transmission of a demodulation reference signal (DMRS) in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a physical downlink control channel (PDCCH) transmission in a control resource set (CORESET). The CORESET may span multiple symbols. The first number of demodulation reference signal (DMRS) resource elements (REs) in a first symbol of the multiple symbols is higher than a second number of DMRS REs in any symbol of the remaining symbols in the multiple symbols, and the DMRS density in the first symbol is based on one or more of a number of symbols in the multiple symbols or a minimum aggregation level for the DMRS REs. The at least one processor, individually or in any combination, may be further configured to communicate with the network entity based on the PDCCH transmission.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, to a UE, a PDCCH transmission in a CORESET spanning multiple symbols. The first number of DMRS RE in the first symbol of the multiple symbols is higher than the second number of DMRS REs in any symbol of the remaining symbols in the multiple OFDM symbols. The DMRS density in the first symbol is based on one or more of a number of symbols in the multiple symbols or the minimum aggregation level for the DMRS REs. The at least one processor, individually or in any combination, may be further configured to communicate with the UE based on the PDCCH transmission.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example demodulation reference signal (DMRS) mapping in the resource element groups (REGs).

FIG. 5A and FIG. 5B are diagrams illustrating DMRS for multi-symbol control resource set (CORESET) in accordance with various aspects of the present disclosure.

FIG. 6 shows diagrams illustrating the partition of a CORESET into multiple sub-CORESETs in accordance with various aspects of the present disclosure.

FIG. 7 are diagrams that illustrate examples of variable DMRS density across the symbols in a CORESET in accordance with various aspects of the present disclosure.

FIG. 8 is a diagram illustrating an example DMRS design in accordance with various aspects of the present disclosure.

FIG. 9 is a call flow diagram illustrating a method of wireless communication in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a network entity in accordance with various aspects of the present disclosure.

FIG. 15 is a flowchart illustrating methods of wireless communication at a network entity in accordance with various aspects of the present disclosure.

FIG. 16 is a diagram illustrating an example of a hardware implementation for an example apparatus and/or UE.

FIG. 17 is a diagram illustrating an example of a hardware implementation for an example network entity.

### DETAILED DESCRIPTION

In wireless communication, a demodulation reference signal (DMRS) is used for various tasks, including channel estimation, signal demodulation, and timing and frequency synchronization. The DMRS may be uniformly distributed within time or frequency domain resources. For example, the DMRS for the physical downlink control channel (PDCCH) is mapped across all resource element groups (REGs) on every symbol (e.g., orthogonal frequency division multiplexing (OFDM) symbol) for a given PDCCH candidate, and the density of the DMRS (e.g., the ratio of the number of the DMRS REs to the total number of REs in an OFDM symbol) is uniformly distributed across all REGs, with DMRS positions (e.g., the locations of the DMRS REs) uniformly spaced within each REG. As used herein, a “DMRS RE” refers to a RE allocated for a DMRS transmission. As DMRS processing is one of the first steps in downlink (DL) processing for control channel (CCH) detection, identifying the absence of a control channel transmission early, e.g., based on the DMRS, can save substantial processing power that would otherwise be spent on unnecessary steps such as attempted decoding and post-channel estimation. Additionally, the DMRS based PDCCH pruning (e.g., detecting the absence of PDCCH or PDCCH DMRS and skipping the blind decoding of the absent PDCCH) can reduce the number of blind decoding processes for PDCCH and lower power consumption in UE. Example aspects presented herein provide methods and apparatus that enhance the DMRS distribution in time and frequency domains to improve the efficiency of DMRS-based PDCCH pruning and enhance the detection of PDCCH absence.

Various aspects relate generally to wireless communication. Some aspects more specifically relate to the transmission of demodulation reference signals (DMRS) in wireless communication. In some examples, a UE may receive a PDCCH transmission in a CORESET from a network entity, and monitor or a PDCCH transmission in the CORESET. The CORESET may span (or include) multiple orthogonal frequency division multiplexing (OFDM) symbols. The first number of DMRS REs in the first OFDM symbol in the multiple OFDM symbols is higher than the second number of DMRS REs in any OFDM symbol of the remaining OFDM symbols in the multiple OFDM symbols. The DMRS density in the first OFDM symbol is based on the number of OFDM symbols in the multiple OFDM symbols or the minimum aggregation level (e.g., the number of REGs used to formulate a PDCCH candidate) for the DMRS REs. The UE may further communicate with the network entity based on the CORESET. In some examples, the number of DMRS REs in the first OFDM symbol may be based on the number of OFDM symbols. For example, if the number of OFDM symbols is less than or equal to a count threshold, all the DMRS REs may be in the first OFDM symbol. Otherwise, if the number of OFDM symbols is greater than the count threshold, at least one DMRS RE may be in the remaining OFDM symbols. In some examples, the CORESET may include multiple sub-CORESETs in the frequency domain, and each sub-CORESET may have one or more DMRS REs if a REG in the sub-CORESET carries the PDCCH. In some examples, for each sub-CORESET, the number of DMRS REs in the first OFDM symbol in the multiple OFDM symbols may be higher than the number of DMRS REs in any OFDM symbol of the remaining OFDM symbols in the multiple OFDM symbols. In some examples, the UE may perform a group-wise PDCCH pruning process to detect the absence of PDCCH for each UE in a group of UEs if a precoder granularity is a first precoder granularity, which includes all continuous RBs in the sub-CORESET. In some examples, the UE may perform a PDCCH pruning process to detect the absence of PDCCH for the UE if the precoder granularity is a second precoder granularity, which includes the size of a REG bundle.

Particular aspects of the subject matter described in this disclosure can be implemented to realize one or more of the following potential advantages. In some examples, by placing the DMRS at the beginning of the CORESET (e.g., front-loading the DMRS on the first symbol of the CORESET), the described techniques allow UEs to detect the absence of control channels earlier in the processing pipeline, thereby conserving processing power that would otherwise be spent on unnecessary processes (e.g., decoding processes). In some examples, by adjusting the DMRS density for the front-loaded DMRS based on the number of OFDM symbols or the minimum aggregation level in the CORESET, the described techniques provide flexibility to adapt to varying network conditions and UE capabilities. In some examples, by implementing DMRS at the beginning of multiple sub-CORESETs in a CORESET (e.g., front-loading the DMRS in multiple sub-CORESETs in a CORESET), the described techniques enable dynamic rate matching and group-wise PDCCH pruning, thereby improving the resource utilization efficiency and reducing the computational burdens on UEs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

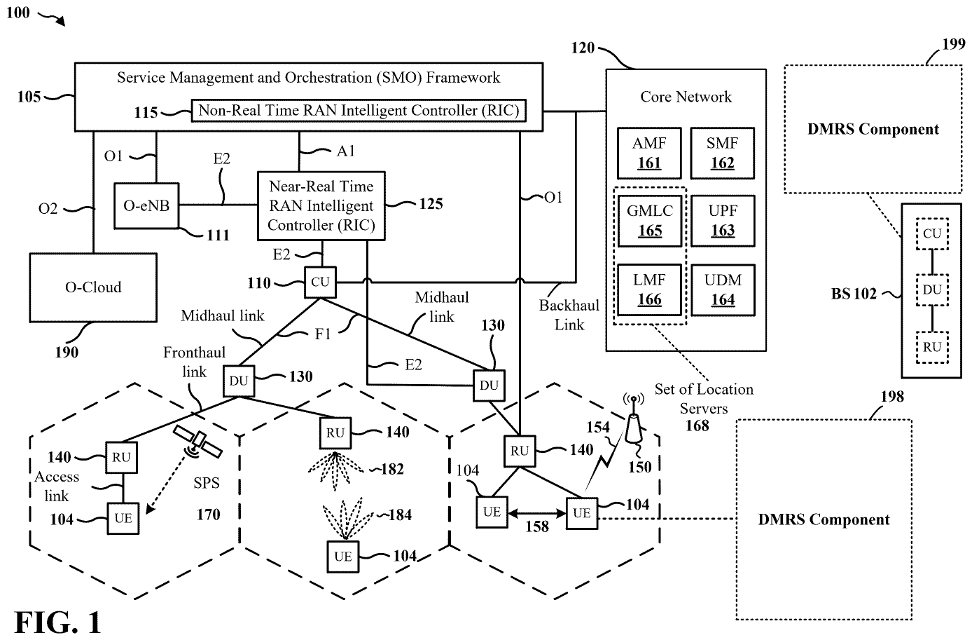

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a DMRS component 198. The DMRS component 198 may be configured to receive a configuration for a CORESET; and monitor for a PDCCH transmission in the CORESET. The CORESET may span (or include) multiple symbols (e.g., OFDM symbols), where a first number of DMRS REs in a first symbol of the multiple symbols is higher than a second number of DMRS REs in any symbol of the remaining symbols in the multiple symbols, where a DMRS density in the first symbol is based on one or more of a number of symbols in the multiple OFDM symbols or a minimum aggregation level for the DMRS REs. In certain aspects, the base station 102 may include a DMRS component 199. The DMRS component 199 may be configured to transmit to a configuration for a CORESET; and transmit, to a UE, a PDCCH transmission in the CORESET. The CORESET may span (or include) multiple symbols (e.g., OFDM symbols), where a first number of DMRS REs in a first symbol of the multiple symbols is higher than a second number of DMRS REs in any symbol of the remaining symbols in the multiple symbols, where a DMRS density in the first symbol is based on one or more of a number of symbols in the multiple symbols or a minimum aggregation level for the DMRS REs. Although the following description may be focused on 5G NR, the concepts described herein may be applicable to other similar areas, such as LTE, LTE-A, CDMA, GSM, and other wireless technologies.

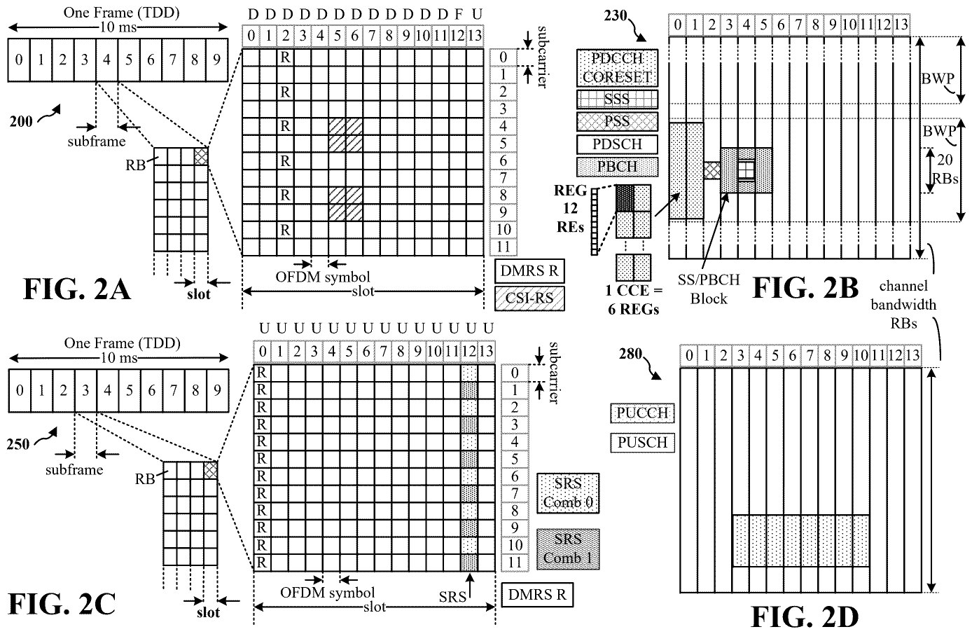

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

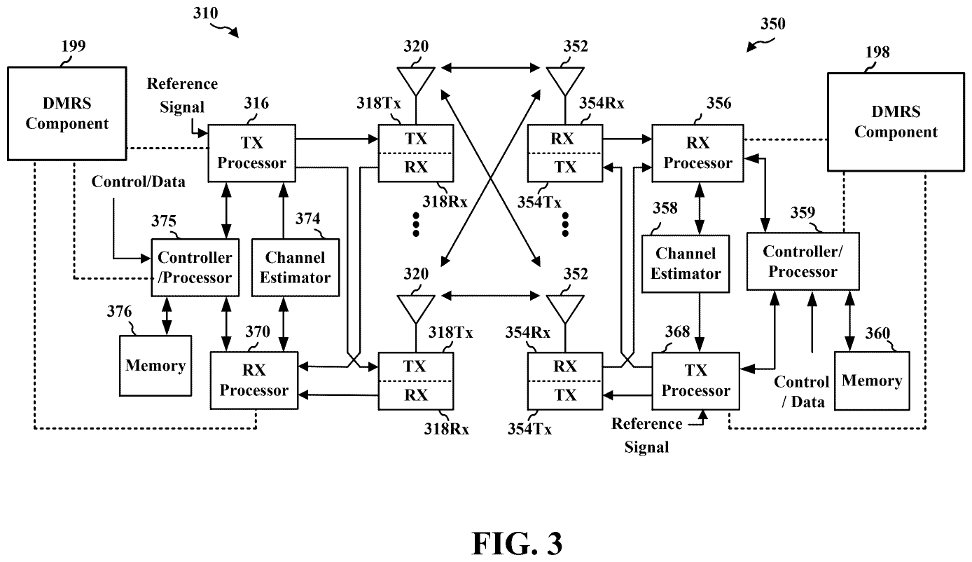

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the DMRS component 198 of FIG. 1.

At least one of the TX processor 316, the RX processor 370, and the controller/processor 375 may be configured to perform aspects in connection with the DMRS component 199 of FIG. 1.

In wireless communication, DMRS can be used for various tasks, including channel estimation, signal demodulation, and timing and frequency synchronization. The DMRS may be uniformly distributed within time or frequency domain resources. For example, the DMRS for the PDCCH is mapped across all resource element groups (REGs) on every OFDM symbol for a given PDCCH candidate, and the density of the DMRS (e.g., the ratio of the number of DMRS REs to the total number of REs in an OFDM symbol) is uniformly distributed across all REGs, with DMRS positions (e.g., the locations of the DMRS REs) uniformly spaced within each REG. As used herein, a “DMRS RE” refers to a RE allocated for a DMRS transmission. Since DMRS processing is one of the first steps in downlink processing for CCH detection, identifying the absence of CCH early based on the DMRS can save substantial processing power that would otherwise be spent on unnecessary steps such as decoding and post-channel estimation. Additionally, the DMRS based PDCCH pruning (e.g., the detection of the absence of PDCCH) can reduce the number of blind decoding processes for PDCCH and lower power consumption in UE. Example aspects presented herein provide methods and apparatus for a front-loaded DMRS design for PDCCH to assist, for example, PDCCH pruning for multi-symbol CORESETs. Instead of the PDCCH DMRS design where the DMRS REs are distributed across all PDCCH symbols, example aspects presented herein allow the DMRS REs to be concentrated in the first PDCCH symbol with an increased density. This configuration enables the receiver to detect the presence of downlink control information (DCI) based on the first symbol of the PDCCH and prune out the rest of PDCCH symbols if the DCI is not present. In some aspects, the DMRS may have different densities over time, for example, with a higher density in the front-loaded DMRS and a lower density in the rear-loaded DMRS.

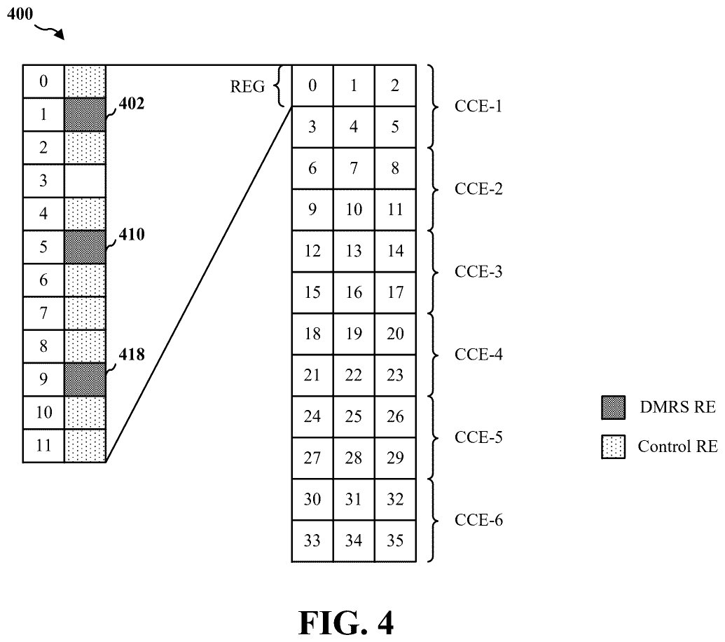

In wireless communication, the DMRS for the PDCCH is mapped across all REGs on all the OFDM symbols of a given PDCCH candidate. The PDCCH candidates are all potential PDCCHs (which may be used to carry downlink control information (DCI)) placed in all the potential time and frequency resources within the CORESET. For example, a PDCCH candidate may represent a set of potential resources in frequency and time domains where the DCI could be transmitted. In some example, since the DCI formats may vary, there may be multiple PDCCH candidates for the same time and frequency resource. The DMRS density (e.g., the ratio of the number of DMRS REs to a total number of REs in an OFDM symbol) is uniformly distributed across all REGs, with DMRS positions (e.g., the locations of the DMRS REs) evenly spaced within each REG. As used herein, a “DMRS RE” refers to a RE allocated for a DMRS transmission. FIG. 4 is a diagram 400 illustrating an example DMRS mapping in the REGs. In the example in FIG. 4, the DMRS density per REG is ¼ for both normal cyclic prefix (NCP) and extended cyclic prefix (ECP). This means one out of every four REs is used for DMRS. For example, the REs used for DMRS (e.g., the DMRS REs) may include RE 1 402, RE 5, 410, and RE 9 418. A control RE is an RE in which a control channel transmission (e.g., PDCCH) is transmitted.

In some examples, to initialize the DMRS sequence or scrambling process, a configurable identifier (ID) for PDCCH DMRS may be used. In some examples, for each control resource set (CORESET) configured by the physical broadcast channel (PBCH), the physical cell ID may be used for DMRS sequence initialization. As used herein, a CORESET refers to a set of resources in frequency and time domains dedicated to the transmission and reception of control information. In some examples, for each CORESET configured by remaining minimum system information (RMSI), a configurable ID for DMRS sequence initialization may be set through RMSI. In some examples, if the configurable ID is not set, the physical cell ID may be used for DMRS sequence initialization. The configurable ID may share the same value range (e.g., 10-bit range) as the physical cell ID. In some examples, for each CORESET configured by UE-specific radio resource control (RRC) signaling, a UE may be configured with a configurable ID,

$${N}_{ID}^{( {n}_{SCID} )} ,$$

for DMRS sequence initialization. For example, the configurable ID

$$( e . g . {N}_{ID}^{( {n}_{SCID} )} )$$

may be a 16-bit scrambling ID with a default value of the physical cell ID and six known bits. For example, the six known bits may be “000000.”

In some examples, both the DMRS and PDCCH may be scrambled using the same sequence (e.g., a length-31 Gold sequence). The DMRS sequence for the PDCCH may be obtained based on a reference point in the frequency domain. In some examples, the reference point may be the first physical resource block (PRB 0) of common PRB used for indexing UE-specific CORESET. In some examples, the reference point may be the first physical resource block (PRB 0) of the initial active downlink bandwidth part (BWP) for a CORESET configured by PBCH or RMSI. In some examples, the Quasi Co-Location (QCL) configuration and indication may be managed on a per CORESET basis.

In some examples, the precoder granularity (e.g., the smallest size, in the unit of REG or wideband, over which a precoding matrix may be applied) associated with the CORESET may be defined in various ways with respect to the physical downlink control channel (PDCCH) REG bundle size. In some examples, the precoding on associated PDCCH transmissions may remain consistent within a REG bundle (e.g., when the precoder granularity is configured as “sameAsREG-bundle”). In this configuration, the PDCCH DMRS RE may span across the physical resource blocks (PRBs) associated with the PDCCH. In some examples, the precoding may be the same across all REGs within a set of contiguous RBs in the CORESET (e.g., when the precoder granularity is configured as “allContiguousRBs”). In this configuration, the PDCCH DMRS RE may be across the entire CORESET region.

In wireless communication, the downlink control information (DCI) is carried by a PDCCH. However, as the location and format of PDCCH is not known to UEs, the UEs may make multiple blind decoding attempts (e.g., up to 44 decoding attempts per slot) to determine the presence of DCI. These numerous attempts result in a significant power drain, as the PDCCH blind detection can be a significant source of UE power consumption. As DMRS processing is one of the first downlink processing steps for control channel (CCH) detection, identifying the absence of CCH early in the process can save substantial processing power that would otherwise be spent on unnecessary steps, such as decoding, and post-channel estimation when the CCH is absent. Detecting the absence of CCH sooner rather than later may lead to significant power savings. Additionally, DMRS-based PDCCH pruning (e.g., PDCCH absence detection) may reduce the number of blind decoding processes, which may further reduce the computational burden of PDCCH processing. Example aspects presented herein provide methods and apparatus to enhance the efficiency of DMRS-based pruning and the detection of PDCCH absence by more quickly determining an absence of the PDCCH and ceasing the blind decoding attempts.

In some aspects, the DMRS may be front-loaded for a multi-symbol CORESET (e.g., a CORESET that spans (or includes) multiple orthogonal frequency division multiplexing (OFDM) symbols) to enhance the efficiency of PDCCH pruning (e.g., PDCCH absence detection). Front-loading the DMRS means distributing the majority of the DMRS on one or more symbols at the beginning of the multi-symbol CORESET (e.g., the first symbol). In some aspects, the whole first symbol of the CORESET may be used for DMRS, which facilitates the early detection of control channels. For example, the improved early detection or absence of the DMRS may enable the UE to efficiently determine whether or not the CORESET will include a PDCCH transmission for this specific UE or a group of UE. As an example, if the UE detects the DMRS in the first symbol of the CORESET, the UE may expect to receive a PDCCH transmission in the CORESET and may continue to perform blind decoding attempts. If the UE does not detect a DMRS in the first symbol of the CORESET, the UE may determine that the CORESET will not include the PDCCH (which may be referred to as the PDCCH being absent from the CORESET or a PDCCH absence in the CORESET). If the CORESET will not include a PDCCH transmission, the UE is able to skip blind decoding for the PDCCH transmission. If the UE more quickly determines the absence of the PDCCH transmission, the UE can more quickly save power by skipping blind decoding. The increased density of the DMRS in the first symbol of the CORESET enables improved PDCCH pruning.

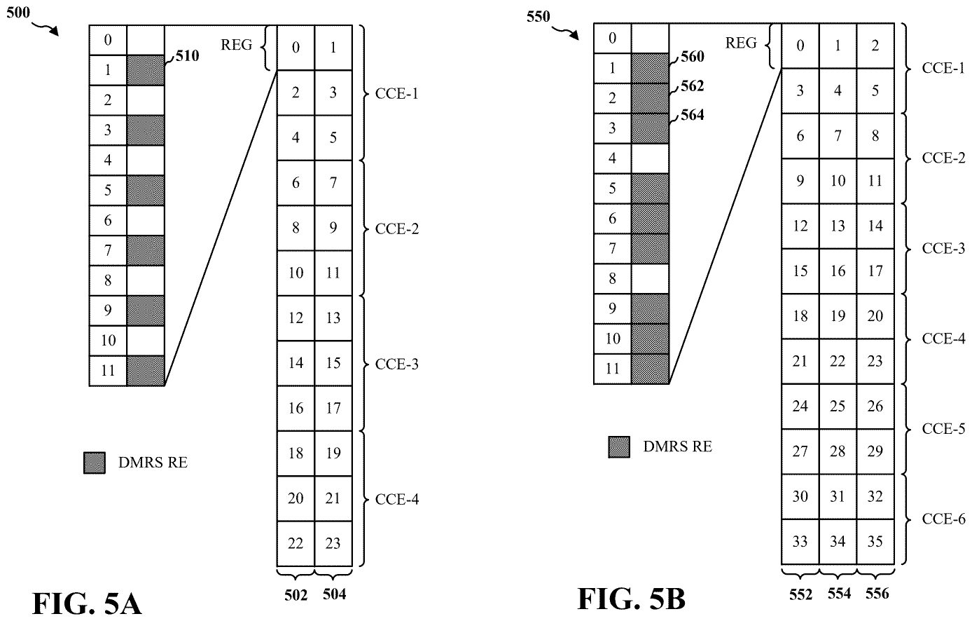

In some aspects, the DMRS density for the front-loaded DMRS may be scalable (e.g., adjustable) according to specific conditions. As used herein, the DMRS density in a symbol refers to the ratio of the number of the DMRS REs to the total number of REs in the symbol. A “DMRS RE” refers to a RE allocated for a DMRS transmission. In some examples, the DMRS density may be scaled (or adjusted) based on the number of symbols (e.g., OFDM symbols) in the CORESET. For example, the DMRS density may increase as the number of symbols in the CORESET increases, and vice versa. FIG. 5A and FIG. 5B are diagrams illustrating the changes in DMRS density with the number of symbols in a multi-symbol CORESET in accordance with various aspects of the present disclosure. As shown in FIG. 5A, in diagram 500, for a CORESET that includes two OFDM symbols (e.g., symbols 502, 504), one RE (e.g., RE 510) out of every two REs in the first symbol may be used for DMRS, resulting in a DMRS density of ½. As shown in FIG. 5B, in diagram 550, for a CORESET that includes three OFDM symbols (e.g., symbols 552, 554, 556), three REs (e.g., REs 560, 562, 564) out of every four REs in the first symbol may be used for DMRS. Thus, the DMRS density increases from ½ to ¾ as the number of symbols in the CORESET increases from 2 to 3.

In some examples, the DMRS density may be scaled (e.g., adjusted) based on the minimum aggregation level (AL). An aggregation level refers to the number of resource element groups (REGs) associated with a PDCCH candidate (e.g., the number of REGs used to formulate a PDCCH candidate). For example, an aggregation level of eight indicates that eight REGs are used to formulate a PDCCH candidate. For example, a smaller minimum AL may lead to a higher DMRS density compared to scenarios with a larger minimum AL, since a smaller minimum AL may necessitate more REs to improve the performance of PDCCH DMRS detection. For example, if the minimum AL increases from 2 to 8, the number of REs used for PDCCH transmissions quadruples. Hence, the DMRS density for a minimum AL of 8 can be lower than the DMRS density for a minimum AL of 2.

In some aspects, the number of symbols in a CORESET may vary based on the capabilities of different types of UEs, and whether the remaining symbols in the CORESET (e.g., the symbols after the first symbol) may be used for DMRS may depend on the total number of symbols (e.g., OFDM symbols) in the CORESET. For example, for a regular UE, such as an enhanced mobile broadband (eMBB) device with four receive antennas, the number of symbols in a CORESET may be small, e.g., less than or equal to a count threshold N (e.g., N=3). In this case, the remaining symbols within the CORESET may be fully used for carrying the PDCCH payload without any DMRS. For example, for these UEs, the first symbol of the multiple symbols in the CORESET may be used for DMRS, while the remaining symbols in the CORESET may be fully used for PDCCH payload. This configuration is adequate when the number of symbols in a CORESET is small (e.g., less than or equal to the count threshold), as the impact of Doppler shift is small under these conditions.

On the other hand, for lower-tier devices, such as an Internet of Things (IoT) device with one receive antenna, the number of symbols in a CORESET may exceed the count threshold N (e.g., the number of symbols in a CORESET is 6, while the count threshold, N=3). In these cases, at least a part of the remaining symbols in the CORESET may be used to transmit DMRS. Increased DMRS REs may be necessary when a CORESET contains a large number of symbols, as the impact of Doppler shifts can be significant. In some examples, the addition of DMRS in these remaining symbols can be configurable, allowing adaptation to different network conditions and device capabilities. For example, the network may allocate at least one DMRS RE in the remaining OFDM symbols based on a configuration that indicates the DMRS RE in these OFDM symbols.

Additionally, in scenarios where the number of symbols in a CORESET is larger than the count threshold (e.g., N), the REG bundle size may be larger than the regular maximum REG bundle size (e.g., 6) to enable DMRS bundling for enhanced channel estimation. In these cases, to avoid the complexity increase for lower-tier UEs (e.g., IoT devices), the aggregation level may be restricted (or limited) to be a large value (e.g., larger than an aggregation threshold) for those UEs where the number of symbols in a CORESET is larger than the count threshold (e.g., N). This restriction may help these UEs to utilize more bundled DMRS for channel estimation.

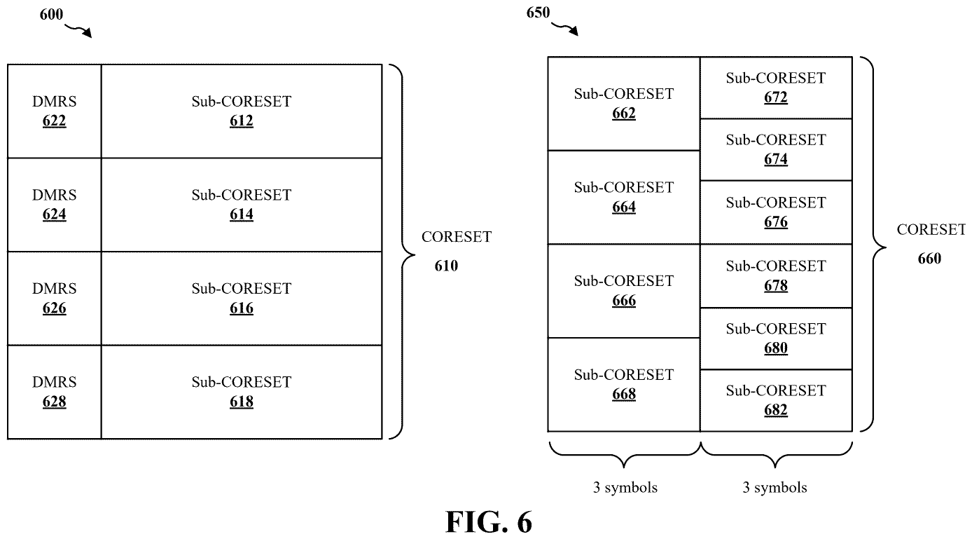

In some aspects, the CORESET may be partitioned into multiple smaller sub-CORESETs to facilitate the PDCCH pruning. FIG. 6 shows diagrams illustrating the partition of a CORESET into multiple sub-CORESETs in accordance with various aspects of the present disclosure. As shown in FIG. 6, in diagram 600, a CORESET 610 may be partitioned into four sub-CORESETS (e.g., sub-CORESET 612, 614, 616, 618). In some examples, by partitioning the CORESET 610, each sub-CORESET (e.g., sub-CORESET 612, 614, 616, 618) may independently support dynamic rate matching. For example, each sub-CORESET may respectively correspond to different precoder granularities.

In some examples, the partitioning of the CORESET 610 into sub-CORESETs may enable the sharing of DMRS among a group of UEs, while simultaneously maintaining effective DMRS pruning (or PDCCH pruning) for this group of UEs. For example, by partitioning the CORESET 610 into four sub-CORESETs (e.g., sub-CORESET 612, 614, 616, 618), each sub-CORESET may correspond to one UE in a group of UEs, and these UEs may share the DMRS in the CORESET 610.

In some aspects, a new level precoder granularity, termed “allContiguousRBs_subCORESET,” may be defined. This precoder granularity means that the precoding remains consistent across all REGs within the set of contiguous RBs in the sub-CORESET. This uniformity ensures that DMRS REs is across the entire sub-CORESET region. In some examples, within each sub-CORESET (e.g., sub-CORESET 612, 614, 616, 618), DMRS may be front-loaded with a high DMRS density. The rule for the front-loading of DMRS and DMRS density in a sub-CORESET may follow that for the CORESET. For example, in sub-CORESET 612, the DMRS may be front-loaded (e.g., all the DMRS may be located within the first symbol in the sub-CORESET 612), and whether there would be additional DMRS in the remaining symbols depends on the number of symbols in sub-CORESET 612. Additionally, the first symbol in the sub-CORESET 612 may have a high DMRS density, the value of which may depend on factors such as the total number of symbols in sub-CORESET 612 or the minimum AL. By partitioning CORESET 610 into multiple sub-CORESETs (e.g., sub-CORESET 612, 614, 616, 618), the DMRS in each sub-CORESET (e.g., DMRS 622, 624, 626, 628) may be used to determine the PDCCH transmission at the sub-CORESET level (e.g., determining which sub-CORESET is used for PDCCH transmission).

In some examples, a CORESET may be partitioned into multiple sub-CORESETs for a subset of its symbols. For example, as shown in diagram 650, if a CORESET 660 includes six symbols, in the first three symbols, the CORESET 660 may be partitioned into four sub-CORESETs (e.g., sub-CORESET 662, 664, 666, 4 668), and the DMRS in each of these sub-CORESETs may be front-loaded and can be used to detect PDCCH transmission in the respective sub-CORESET. For the remaining three symbols, there may either be no partitioning or a different partitioning strategy could be applied. For example, as shown in diagram 650, in the remaining three symbols, the CORESET may be partitioned into six sub-CORESETs (e.g., sub-CORESET 672, 674, 676, 678, 680, 682). This strategy allows for a flexible selection of sub-CORESETs for PDCCH pruning.

In some aspects, the use of a front-loaded DMRS in sub-CORESET configurations may enhance the precision and efficiency of PDCCH pruning. In some examples, when the precoder granularity is set to “allContiguousRBs_subCORESET,” meaning the precoding is consistent across all REGs within the set of contiguous RBs in the sub-CORESET, the front-loaded DMRS enables effective group-wise PDCCH pruning. In such configurations, DMRS for PDCCH may be consistently transmitted in the sub-CORESET whenever the sub-CORESET carries PDCCH, regardless of the aggregation level within the sub-CORESET.

On the other hand, when the precoder granularity is “sameAsREG-bundle,” meaning the precoding remains consistent within a REG bundle, the front-loaded DMRS may fall back to the original UE-specific PDCCH pruning (e.g., the PDCCH pruning is performed for each individual UE). In this scenario, DMRS RE is limited to those REGs that carry PDCCH. To further improve the reliability of PDCCH pruning, the AL in sub-CORESET may be restricted (or limited) to larger values (e.g., larger than the aggregation threshold). For example, the PDCCH pruning (or DMRS pruning) may be performed when the AL has a large value (e.g., larger than the aggregation threshold).

In some aspects, for CORESETs that include a large number of symbols (e.g., exceeding the count threshold), the DMRS may be both front-loaded and rear-loaded, meaning the DMRS are concentrated on the symbols located at the beginning and the end of the CORESET (e.g., the first symbol and the last symbol in the CORESET). For example, in a CORESET that includes three or more symbols, front and rear loaded DMRS may be used to compensate for Doppler effects that may impact signal clarity and reception. In some examples, the front-loaded DMRS (e.g., located at the first symbol of the CORESET) may have a higher DMRS density, while the rear-loaded DMRS (e.g., located at the last symbol of the CORESET) may have a lower DMRS density compared to the front-loaded DMRS. For example, the DMRS may be front and rear loaded, distributed at the first and last symbols in the CORESET. The front-loaded DMRS may have a DMRS density of ½ in the first symbol of the CORESET, whereas the rear-loaded DMRS may have a DMRS density of 1/12 in the last symbol of the CORESET.

In some aspects, the DMRS may have variable density across the time domain (e.g., across the symbols) in the CORESET. In some examples, the variable DMRS density across the time domain may be designed to balance performance with power savings effectively. In some examples, DMRS resource elements (REs) may be uniformly distributed in the frequency domain. In some examples, the DMRS density across the time domain may change, with the highest density occurring on the first symbol of the CORESET.

In some examples, the distribution of DMRS density across the time domain may be defined under the constraint of an overall DMRS overhead (or a common DMRS overhead). For example, the density of DMRS in the i-th symbol of the CORESET may be defined as dᵢ, where i=1, 2, . . . , I, and I is the total number of symbols in the CORESET. The overall DMRS overhead may be defined as D. For example, if D equals ¼, it means, on average, one out of every four REs will be used for DMRS. In some examples, the variable DMRS density over time may be designed such that:

$${max}_{i} {d}_{i} = {d}_{1}$$

(i.e., the first symbol in the CORESET has the highest DMRS density), and

$${\sum }_{i = 1}^{I} {d}_{i} / I = D$$

(i.e., the average DMRS density across all symbols in the CORESET is D).

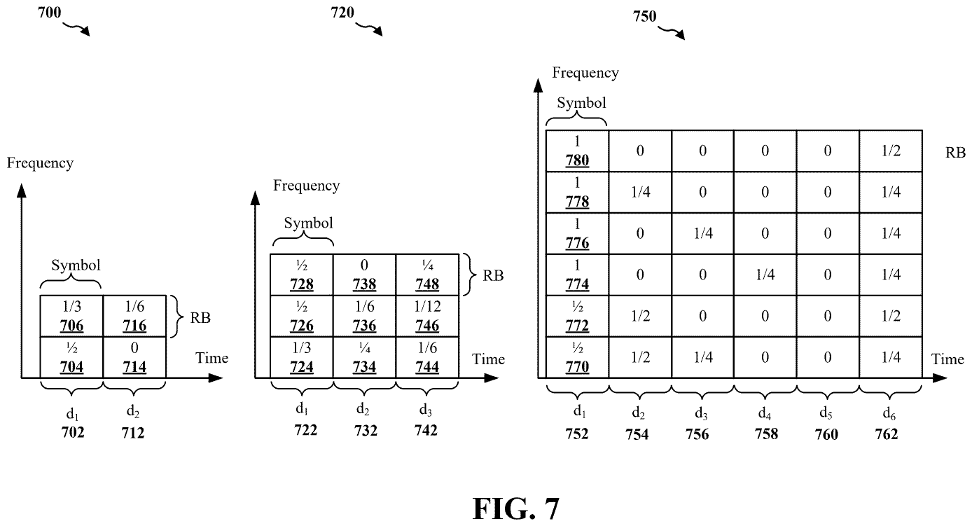

FIG. 7 shows diagrams that illustrate examples of variable DMRS density across the symbols in a CORESET in accordance with various aspects of the present disclosure. In diagram 700, the CORESET includes two symbols: symbol d₁ 702 and d₂ 712. Each symbol may include two RBs (e.g., RB 704, 706 for symbol d₁ 702, and RB 714, 716 for symbol d₂ 712). These symbols may have different DMRS densities. The first symbol d₁ 702 may have the highest DMRS density of 5/12 (i.e., (⅓+½)/2= 5/12). This DMRS density is higher than the DMRS density of symbol d₂ 712, which is 1/12 (i.e., (⅙+0)/2= 1/12). The distribution of the DMRS density across all the symbols in this CORESET may be constrained by an overall DMRS overhead of D=¼. For example, the average DMRS density across all the symbols (e.g., symbol d₁ 702 and symbol d₂ 712) is D=¼ (i.e., ( 5/12+ 1/12)/2=¼).

In diagram 720, the CORESET includes three symbols: symbol d₁ 722, symbol d₂ 732, and symbol d₃ 742. Each symbol may include three RBs (e.g., RB 724, 726, 728 for symbol d₁ 722, RB 734, 736, 738 for symbol d₂ 732, and RB 744, 746, 748 for symbol d₃ 742). These symbols may have different DMRS densities. The first symbol d₁ 722 may have the highest DMRS density of 4/9 (i.e., (½+½+⅓)/3= 4/9) among these three symbols. This DMRS density is higher than the DMRS density of symbol d₂ 732 and symbol d₃ 742, which is 5/36 (i.e., (¼+⅙+0)/3= 5/36) and ⅙ (i.e., (¼+ 1/12+⅙)/3=⅙), respectively. The distribution of the DMRS density across all the symbols in this CORESET may be constrained by an overall DMRS overhead of D=¼. For example, the average DMRS density across all the symbols in this CORESET (e.g., symbol d₁ 722, d₂ 732, d₃ 742) is D=¼ (i.e., ( 4/9+ 5/36+⅙)/3=¼).

In diagram 750, the CORESET includes six symbols: symbol d₁ 752, d₂ 754, d₃ 756, d₄ 758, d₅ 760, d₆ 762. Each symbol may include six RBs (e.g., RB 770, 772, 774, 776, 778, 780 for symbol d₁ 752). These symbols may have different DMRS densities. The first symbol d₁ 752 may have the highest DMRS density of ⅚ (i.e., (1+1+1+1+½+½)/6=⅚) among these six symbols. This DMRS density is higher than the DMRS density of other symbols (e.g., symbol d₂ 754, d₃ 756, d₄ 758, d₅ 760, d₆ 762), such as the DMRS density of 5/24 for symbol d₂ 754, the DMRS density of 1/12 for symbol d₃ 756, the DMRS density of 1/24 for symbol d₄ 758, the DMRS density of 0 for symbol d₅ 760, and the DMRS density of ⅓ for symbol d₆ 762. The distribution of the DMRS density across all the symbols in this CORESET may be constrained by an overall DMRS overhead of D=¼. For example, the average DMRS density across all the symbols in this CORESET (e.g., symbol d₁ 752, d₂ 754, d₃ 756, d₄ 758, d₅ 760, d₆ 762) is D=¼.

In some aspects, the variable DMRS density pattern may be determined based on various factors, such as the CORESET symbol duration (e.g., the number of symbols in a CORESET) and the minimum aggregation level across the configured search spaces. In some examples, the variable DMRS density pattern may be determined based on the characteristics of the UE with the highest Doppler effect among all the served UEs or the UE with the worst link quality, such as those with the lowest reference signal received power (RSRP) or signal-to-interference-plus-noise ratio (SINR), among all the served UEs.

In some aspects, multiple options are available for adapting the variable DMRS density pattern. In some examples, the variable DMRS density pattern may be predetermined (e.g., defined in a wireless communication standard) according to the CORESET duration in the time domain (e.g., number of symbols in a CORESET) and/or the minimum AL across the configured search spaces. In some examples, during the CORESET configuration, the network may explicitly signal which variable DMRS density pattern to use. In some examples, the network may configure multiple CORESETs, each with different variable DMRS density patterns. In some examples, the network might re-use the framework of the SSS or SSS group (SSSG) switch to facilitate dynamic pattern adaptation (e.g., the dynamic adaption of the DMRS density pattern).

In some aspects, the adaptation of variable DMRS density patterns may be predetermined, for example, defined in a wireless communication standard. For example, a default variable DMRS density pattern may be defined (e.g., in a wireless communication standard) for each CORESET duration in the time domain (e.g., the number of symbols in a CORESET) and/or each minimum aggregation level (AL) across the configured search spaces. In some aspects, a group of variable DMRS density patterns may be defined (e.g., in a wireless communication standard). The group of DMRS density patterns may be based on (or is a function of) a CORESET duration in the time domain (e.g., a number of symbols in a CORESET) and/or a minimum aggregation level across the configured search spaces.

In some aspects, based on the predetermined DMRS density pattern or a group of DMRS density patterns, the network may semi-statically switch the variable DMRS density pattern for the CORESET using radio resource control (RRC) signaling or a system information block (SIB). In some aspects, the network may configure a group of candidate variable DMRS density patterns through RRC messages. Based on this configuration, the network may dynamically switch the variable DMRS density pattern using downlink control information (DCI) or a medium access control (MAC)—control elements (MAC-CE).

In some aspects, by default, the UE may support the default variable DMRS density pattern for each CORESET duration in the time domain (e.g., each number of symbols in a CORESET). In some examples, the UE may report its ability to support non-default variable DMRS density patterns it could support.

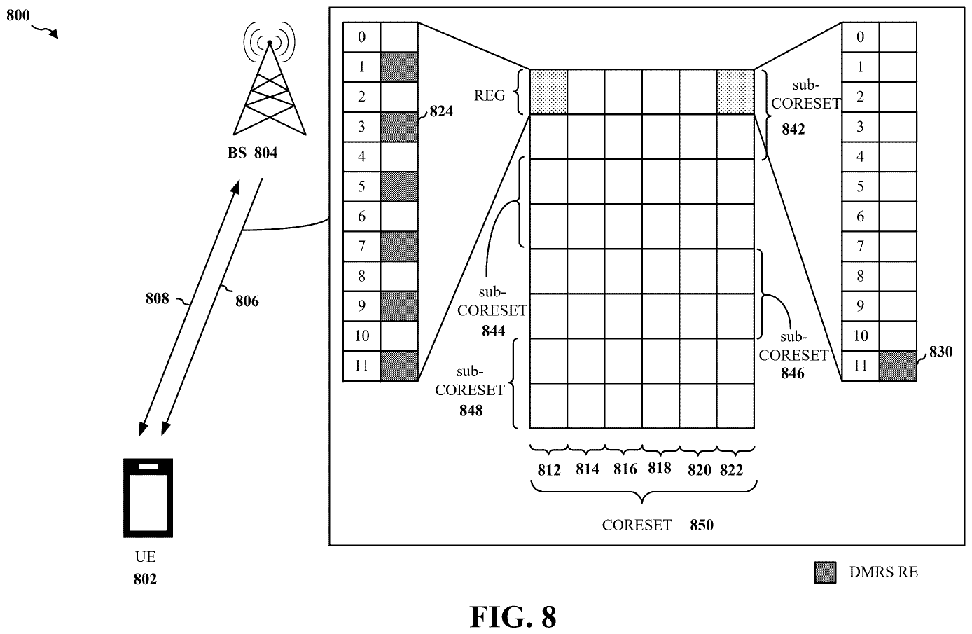

FIG. 8 is a diagram 800 illustrating an example of the DMRS design in accordance with various aspects of the present disclosure. As shown in FIG. 8, the base station 804 may, at 806, transmit a PDCCH transmission to UE 802 in a CORESET 850. The CORESET may span (or include) multiple (e.g., six) OFDM symbols (e.g., symbol 812, 814, 816, 818, 820, 822). Rather than distributing the DMRS evenly across these symbols and the REs within each symbol, the DMRS may be front-loaded. For example, the DMRS may be located in the first symbol 812, while the remaining symbols (e.g., symbol 814, 816) may be used entirely for transmitting the PDCCH payload without transmitting DMRS. In some examples, when the CORESET includes a large number of symbols, such as six symbols, at least part of the DMRS may be located at the remaining symbols (e.g., symbol 814, 816, 818, 820, or 822). The DMRS density (e.g., the ratio of the number of REs used for DMRS to the total number of REs in a symbol) in the first symbol 812 may be adjust based on, for example, the total number of symbols in the CORESET 850 or the minimum aggregation level. For example, a higher aggregation level may lead to a lower DMRS density.

In some examples, when the CORESET includes a large number of symbols, such as six symbols, the DMRS, with the PDCCH transmission, may be both front-loaded and rear-loaded, meaning the DMRS are concentrated on the symbols located at the beginning and the end of the CORESET (e.g., the first symbol 812 and the last symbol 822 in the CORESET 850). The front-loaded DMRS, located at the first symbol 812, may have a higher DMRS density than the rear-loaded DMRS, located at the last symbol 822. For example, in the first symbol 812, one RE (e.g., RE 824) out of every two REs is used for DMRS, resulting in a DMRS density of ½ in the first symbol 812 of the CORESET 850. In contrast, at the last symbol 822, one RE (e.g., RE 830) out of every twelve REs is used for DMRS, resulting in a DMRS density of 1/12 in the last symbol 822 of the CORESET 850.

In some examples, the CORESET 850 may be partitioned into multiple (e.g., four) sub-CORESETs (e.g., sub-CORESET 842, 844, 846, 848). Each sub-CORESET (e.g., sub-CORESET 842, 844, 846, 848) may independently support dynamic rate matching. In some examples, the partitioning of the CORESET 850 into sub-CORESETs may enable the sharing of DMRS among a group of UEs.

Based on the CORESET 850, specifically the front-loaded DMRS in the CORESET 850, the UE 802 may perform the PDCCH pruning process (e.g., PDCCH absence or PDCCH DMRS absence detection). For example, if no PDCCH transmission is detected for a location, the UE 802 may skip (or omit) the steps relevant to PDCCH reception (e.g., decoding steps) at that location. In some aspects, as shown at 808, the UE 802 and base station 804 may communicate based on PDCCH received in the CORESET 850.

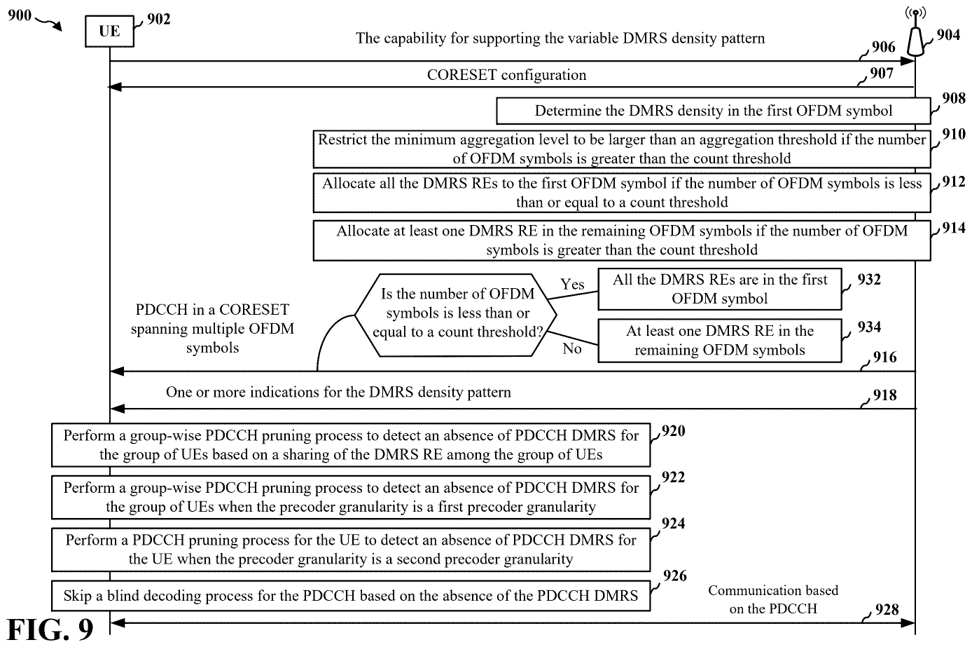

FIG. 9 is a call flow diagram 900 illustrating a method of wireless communication in accordance with various aspects of this present disclosure. Various aspects are described in connection with a UE 902 and a base station 904. The aspects may be performed by the UE 902 or the base station 904 in aggregation and/or by one or more components of a base station 904 (e.g., a CU 110, a DU 130, and/or an RU 140).

As shown in FIG. 9, at 906, the UE may indicate to the base station 904 a capability of the UE for supporting the variable DMRS density pattern (e.g., different DMRS densities for symbol d₁ 702 and d₂ 712).

As shown at 907, the base station 904 may transmit a CORESET configuration to the UE. In some aspects, the configuration may be based on the capability that the UE indicated at 906. The UE 902 may monitor for PDCCH transmissions from the base station 904 in the resources (e.g., including time and frequency resources) configured for the CORESET in the CORESET configuration.

At 908, the base station 904 may determine the DMRS density in the first OFDM symbol of a CORESET. The UE may similarly determine the DMRS density in order to receive the DMRS. In some examples, the DMRS density may be based on one or more of the number of OFDM symbols in the multiple OFDM symbols or the minimum aggregation level. For example, a CORESET with fewer symbols may have a lower DMRS density than a CORESET with more symbols. For example, as shown in FIG. 5A, for a CORESET that includes two OFDM symbols (e.g., symbols 502, 504), one RE (e.g., RE 510) out of every two REs in the first symbol may be used for DMRS, resulting in a DMRS density of ½. In FIG. 5B, for a CORESET that includes three OFDM symbols (e.g., symbols 552, 554, 556), three REs (e.g., REs 560, 562, 564) out of every four REs in the first symbol may be used for DMRS. Thus, the DMRS density increases from ½ to ¾ as the number of symbols in the CORESET increases from 2 to 3. For example, if the minimum AL increases from 2 to 8, the DMRS density for minimum AL of 8 can be lower than the DMRS density for minimum AL of 2. In some examples, in addition to the number of OFDM symbols in the CORESET and the minimum aggregation level of the DMRS RE, the base station 904 may consider additional factors when determining the DMRS density. These factors may include, for example, the highest Doppler effect among all served UEs of the base station 904, or the worst link quality among the served UEs of the base station 904.

At 910, the base station 904 may restrict the minimum aggregation level to be larger than an aggregation threshold if the number of OFDM symbols is greater than the count threshold.

At 912, the base station 904 may allocate all the DMRS REs to the first OFDM symbol if the number of OFDM symbols is less than or equal to the count threshold. For example, referring to FIG. 5A, all the DMRS REs may be allocated to the first OFDM symbol 502 if the number of OFDM symbols (e.g., two) is less than or equal to the count threshold (e.g., N=3).

At 914, the base station 904 may allocate at least one DMRS RE in the remaining OFDM symbols if the number of OFDM symbols is greater than the count threshold. For example, referring to FIG. 8, if the number of OFDM symbols (e.g., six) is greater than the count threshold (e.g., N=3), at least one DMRS RE in the remaining OFDM symbol (e.g., symbol 822).

The UE 902 may then monitor for PDCCH transmissions in the CORESET configured, e.g., at 907. In some aspects, the UE may attempt to detect DMRS in the CORESET to determine whether PDCCH is present or absent in the CORESET, or to determine whether to perform blind decoding for the PDCCH transmission in the CORESET. If the UE determines that the PDCCH is not present, the UE may skip blind decoding for the PDCCH transmission. If the UE detects a DMRS, the UE may continue to monitor for the PDCCH transmission

In some aspects, at 916, the base station 904 may transmit a CORESET that spans (or includes) multiple OFDM symbols to UE 902. The DMRS may be front-loaded, placed in the symbols at the beginning of the CORESET (e.g., the first symbol). The inclusion of DMRS in subsequent OFDM symbols may depend on the total number of OFDM symbols in the CORESET. For example, if the total number of OFDM symbols is small, e.g., less than or equal to the count threshold, all the DMRS RES may be located in the symbols at the beginning of the CORESET (e.g., the first symbol), as indicated at 932. On the other hand, if the total number of OFDM symbols is larger, e.g., greater than the count threshold, at least one DMRS RE may be located in the subsequent OFDM symbols (e.g., remaining OFDM symbols) of the CORESET (e.g., symbols beyond the first symbol), as indicated at 934.

The UE may use the DMRS received with the PDCCH to perform a channel estimation (e.g., perform a channel estimation using the DMRS), and may use the channel estimation to assist in the reception of the corresponding PDCCH.

In some examples, the CORESET may span (or include) multiple sub-CORESETs. For example, referring to FIG. 6, the CORESET 610 may be partitioned into four sub-CORESETs (e.g., sub-CORESET 612, 614, 616, 618). The partitioning of the CORESET 610 into sub-CORESETs may enable the sharing of DMRS among a group of UEs.

In some examples, at 918, the UE 902 may receive one or more indications of the DMRS density pattern from base station 904. In some examples, the UE 902 may receive one indication (e.g., a CORESET configuration), which may indicate the DMRS density pattern used in the CORESET. For example, referring to FIG. 7, if the CORESET includes two symbols, such as symbol d₁ 702 and d₂ 712, the one indication may indicate that the DMRS density is 5/12 for the symbol b₁ 702 and 1/12 for symbol b₂ 712.

In some examples, at 918, the UE 902 may receive multiple indications for the DMRS density pattern from base station 904. For example, the UE 902 may first receive from base station 904, via an RRC message, one indication for the multiple candidate DMRS density patterns. Subsequently, the UE 902 may further receive from base station 904, via RRC signaling or an SIB, another indication of the DMRS density pattern from the multiple candidate DMRS density patterns.

At 920, the UE 902 may detect the presence or absence of the PDCCH transmission based on a group-wise PDCCH pruning process to detect an absence of PDCCH DMRS for the group of UEs based on the sharing of the DMRS REs among the group of UEs.

At 922, the UE 902 may perform a group-wise PDCCH pruning process to detect an absence of PDCCH DMRS for the group of UEs when the precoder granularity is a first precoder granularity. The first precoder granularity may include all continuous RBs in the sub-CORESET.

At 924, the UE 902 may perform a PDCCH pruning process for the UE to detect an absence of PDCCH DMRS for the UE, e.g., as an individual UE, when the precoder granularity is a second precoder granularity. The second precoder granularity may include the size of a REG bundle.

In some aspects at 926, the UE 902 may skip a blind decoding process for the PDCCH based on the absence of the PDCCH DMRS. The UE may determine that the PDCCH is absent based on not detecting the PDCCH DMRS.

At 928, the UE 902 may communicate with the base station 904 based on the PDCCH, if received, in the CORESET.

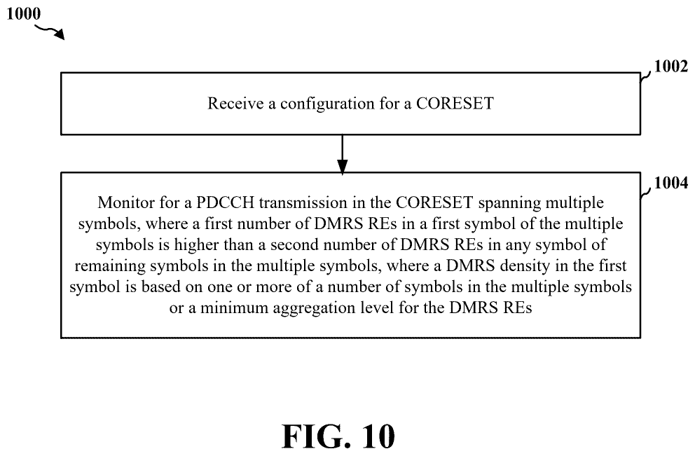

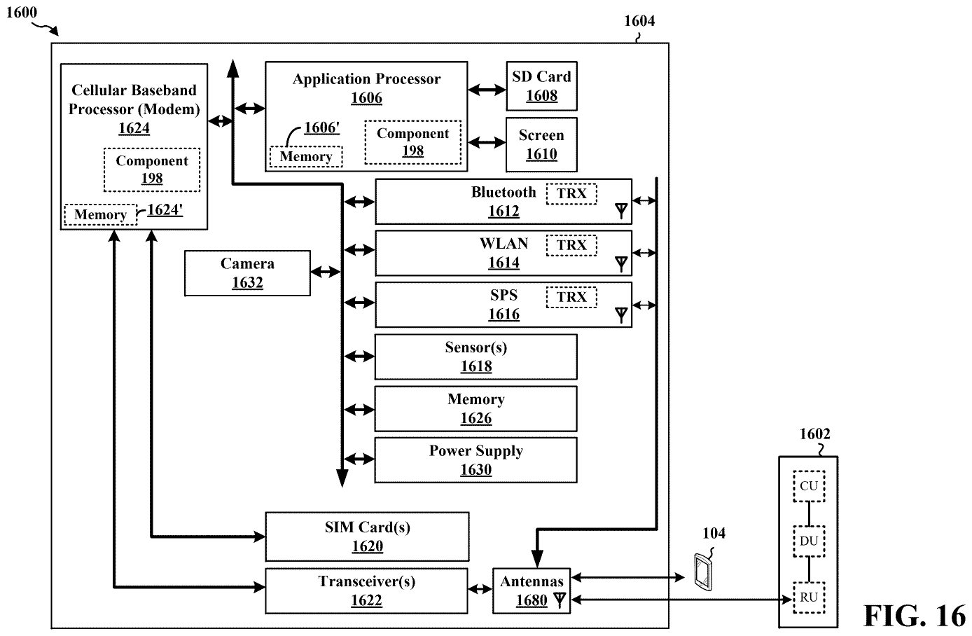

FIG. 10 is a flowchart 1000 illustrating methods of wireless communication at a UE in accordance with various aspects of the present disclosure. The method may be performed by a UE in corporation with a network entity. The network entity may be a base station, or a component of a base station, in the access network of FIG. 1 or a core network component (e.g., base station 102, 310, 804, 904; or the network entity 1602 in the hardware implementation of FIG. 16). The UE may be the UE 104, 350, 802, 902, or the apparatus 1604 in the hardware implementation of FIG. 16. By front-loading the DMRS on the first symbol of the CORESET, the methods allow UEs to detect the absence of control channels earlier in the processing pipeline, thereby conserving processing power that would otherwise be spent on unnecessary processes (e.g., decoding processes). Additionally, by adjusting the DMRS density based on the number of OFDM symbols or the minimum aggregation level in the CORESET, the methods provide flexibility to adapt to varying network conditions and UE capabilities. In some examples, by front-loading the DMRS in multiple sub-CORESETs in a CORESET, the methods enable dynamic rate matching and group-wise PDCCH pruning, thereby improving the resource utilization efficiency and reducing the computational burdens on UEs.

As shown at 1002, the UE may receive a configuration for a CORESET. The CORESET configuration may indicate time and/or frequency resources for the UE to monitor for PDCCH transmissions from a network entity. In some aspects, 1002 may be performed by the DMRS component 198.

As shown in FIG. 10, at 1004, the UE may monitor for a PDCCH transmission (e.g., from the network entity) in the CORESET. The CORESET may span (or include) multiple symbols (e.g., OFDM symbols). The first number of DMRS REs in the first symbol of the multiple symbols may be higher than a second number of DMRS REs in any symbol of the remaining symbols in the multiple symbols. The DMRS density in the first symbol may be based on the number of symbols in the multiple symbols or the minimum aggregation level for the DMRS REs. FIG. 5A, FIG. 5B, FIG. 6, FIG. 7, FIG. 8, and FIG. 9 illustrate various aspects of the steps in connection with flowchart 1000. For example, referring to FIG. 8 and FIG. 9, the UE 902 may, at 916, receive a CORESET from the network entity (e.g., base station 904). Referring to FIG. 8, the CORESET 850 may span (or include) multiple (e.g., six) OFDM symbols. The first number of DMRS REs in the first OFDM symbol 812 in the multiple OFDM symbols may be higher than a second number of DMRS REs in any OFDM symbol of the remaining OFDM symbols (e.g., symbol 814, 816, 818, 820, 822) in the multiple OFDM symbols. The DMRS density (e.g., ½) in the first OFDM symbol (e.g., symbol 812) may be based on the number of OFDM symbols in the multiple OFDM symbols or the minimum aggregation level for the DMRS REs. In some aspects, 1004 may be performed by the DMRS component 198.

In some aspects, the UE may communicate with the network entity based on the CORESET. For example, referring to FIG. 9, the UE 902 may, at 928, communicate with the network entity (e.g., base station 904) based on the CORESET.

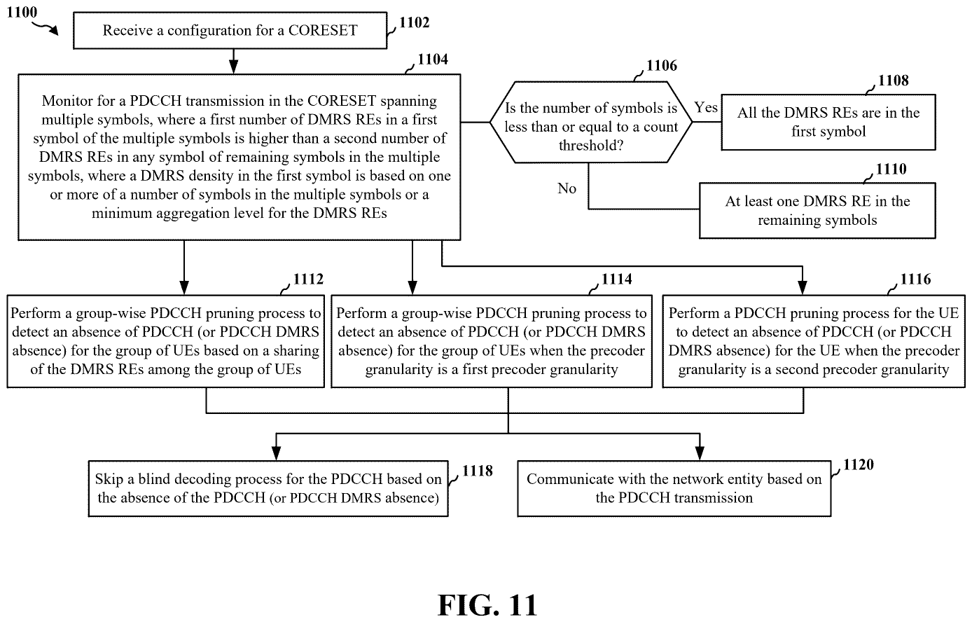

FIG. 11 is a flowchart 1100 illustrating methods of wireless communication at a UE in accordance with various aspects of the present disclosure. The method may be performed by a UE in corporation with a network entity. The network entity may be a base station, or a component of a base station, in the access network of FIG. 1 or a core network component (e.g., base station 102, 310, 804, 904; or the network entity 1602 in the hardware implementation of FIG. 16). The UE may be the UE 104, 350, 802, 902, or the apparatus 1604 in the hardware implementation of FIG. 16. By front-loading the DMRS on the first symbol of the CORESET, the methods allow UEs to detect the absence of control channels earlier in the processing pipeline, thereby conserving processing power that would otherwise be spent on unnecessary processes (e.g., decoding processes). Additionally, by adjusting the DMRS density based on the number of OFDM symbols or the minimum aggregation level in the CORESET, the methods provide flexibility to adapt to varying network conditions and UE capabilities. In some examples, by front-loading the DMRS in multiple sub-CORESETs in a CORESET, the methods enable dynamic rate matching and group-wise PDCCH pruning, thereby improving the resource utilization efficiency and reducing the computational burdens on UEs.

As shown at 1102, the UE may receive a configuration for a CORESET. The CORESET configuration may indicate time and/or frequency resources for the UE to monitor for PDCCH transmissions from a network entity. In some aspects, 1102 may be performed by the DMRS component 198.

As shown in FIG. 11, at 1104, the UE may receive a CORESET from the network entity. The CORESET may span (or include) multiple symbols (e.g., OFDM symbols). The first number of DMRS REs in the first symbol of the multiple symbols may be higher than a second number of DMRS REs in any symbol of the remaining symbols in the multiple symbols. The DMRS density in the first symbol may be based on the number of symbols in the multiple symbols or the minimum aggregation level for the DMRS REs. FIG. 5A, FIG. 5B, FIG. 6, FIG. 7, FIG. 8, and FIG. 9 illustrate various aspects of the steps in connection with flowchart 1100. For example, referring to FIG. 8 and FIG. 9, the UE 902 may, at 916, receive a CORESET from the network entity (e.g., base station 904). Referring to FIG. 8, the CORESET 850 may span (or include) multiple (e.g., six) OFDM symbols. The first number of DMRS REs in the first OFDM symbol 812 in the multiple OFDM symbols may be higher than a second number of DMRS REs in any OFDM symbol of the remaining OFDM symbols (e.g., symbol 814, 816, 818, 820, 822) in the multiple OFDM symbols. The DMRS density (e.g., ½) in the first OFDM symbol (e.g., symbol 812) may be based on the number of OFDM symbols in the multiple OFDM symbols or the minimum aggregation level for the DMRS REs. In some aspects, 1104 may be performed by the DMRS component 198.

At 1120, the UE may communicate with the network entity based on the CORESET. For example, referring to FIG. 9, the UE 902 may, at 928, communicate with the network entity (e.g., base station 904) based on the CORESET. In some aspects, 1120 may be performed by the DMRS component 198.

In some aspects, the DMRS density includes a ratio of a number of the DMRS REs to the total number of REs in a symbol, and all the REs in the first symbol are the DMRS REs. For example, referring to FIG. 8, the DMRS density includes the ratio of a number of the DMRS REs (e.g., RE 824) to the total number of REs in an OFDM symbol (e.g., symbol 812), and all the REs in the first OFDM symbol may be the DMRS RES.

In some aspects, the remaining symbols do not include any DMRS RE. For example, referring to FIG. 5A, when the number of symbols in a CORESET is small (e.g., less than the count threshold), the remaining OFDM symbols (e.g., symbol 504) do not include any DMRS RE.

In some aspects, whether the remaining symbols have DMRS RE may depend on the number of symbols in the CORESET (e.g., at 1106). For example, if the number of symbols is less than or equal to a count threshold, all the DMRS REs may be in the first symbol (e.g., at 1108). Otherwise, if the number of symbols is greater than the count threshold, at least one DMRS RE may be in the remaining symbols (e.g., at 1110). For example, referring to FIG. 5A and FIG. 8, if the number of OFDM symbols (e.g., two) is less than or equal to a count threshold (e.g., N=3), all the DMRS REs may be in the first OFDM symbol 502. Otherwise, if the number of OFDM symbols (e.g., six) is greater than the count threshold (e.g., N=3), at least one DMRS RE may be in the remaining OFDM symbols (e.g., symbol 822). For example, referring to FIG. 9, if the number of OFDM symbols is less than or equal to a count threshold, all the DMRS REs may be in the first OFDM symbol (e.g., at 932). Otherwise, if the number of OFDM symbols is greater than the count threshold, at least one DMRS RE may be in the remaining OFDM symbols (e.g., at 934).

In some aspects, the presence of the DMRS RE in the remaining symbols may be based on a DMRS configuration that indicates the presence of the DMRS RE in the remaining symbols. For example, referring to FIG. 8, the presence of the DMRS RE in the remaining OFDM symbols (e.g., symbol 822) may be based on a DMRS configuration that indicates the DMRS RE in the remaining OFDM symbols.

For example, the minimum aggregation level may be larger than an aggregation threshold, and the aggregation level may include the number of REG associated with a PDCCH candidate.

In some aspects, the last symbol in the multiple symbols includes a third number of DMRS REs, and the third number of DMRS REs is larger than a number of DMRS REs in any other symbols in the multiple symbols except for the first symbol and the last symbol. For example, referring to FIG. 8, the last OFDM symbol 822 in the multiple OFDM symbols includes a third number of DMRS REs, and the third number is larger than a number of DMRS REs in any other OFDM symbols in the multiple OFDM symbols except for the first OFDM symbol and the last OFDM symbol, such as symbol 814, 816, 818, 820.

In some aspects, the first number of DMRS REs may be greater than the third number of DMRS REs. For example, referring to FIG. 8, the first number of DMRS REs in symbol 812 is greater than the third number of DMRS REs in symbol 822.

In some aspects, the CORESET may include multiple sub-CORESETs in a frequency domain, and each sub-CORESET may have a DMRS RE if the REG in the sub-CORESET carries PDCCH. For each sub-CORESET, a fourth number of DMRS REs in the first OFDM symbol in the multiple symbols is higher than a fifth number of DMRS REs for any symbol of the remaining symbols in the multiple symbols. For example, referring to FIG. 6, the CORESET 610 may include multiple sub-CORESETs (e.g., sub-CORESET 612, 614, 616, 618) in a frequency domain, and each sub-CORESET may have a DMRS RE if the REG in the sub-CORESET carries PDCCH. For each sub-CORESET (e.g., sub-CORESET 612, 614, 616, 618), a fourth number of DMRS REs (e.g., DMRS 622, 624, 626, 628) in the first OFDM symbol in the multiple OFDM symbols is higher than a fifth number of DMRS REs for any OFDM symbol of the remaining OFDM symbols in the multiple OFDM symbols.

In some aspects, each sub-CORESET respectively corresponds to different precoder granularities. For example, referring to FIG. 8, each sub-CORESET (e.g., sub-CORESET 842, 844, 846, 848) may respectively correspond to different precoder granularities (e.g., when the precoder granularity for PDCCH is set at “allContiguousRBs_subCORESET”).

In some aspects, the UE may be a first UE, and the DMRS REs may be shared among a group of UEs comprising the first UE and a second UE based on the multiple sub-CORESETs. For example, referring to FIG. 8, the DMRS REs may be shared among a group of UEs comprising the UE 802 and a second UE based on the multiple sub-CORESETs (e.g., sub-CORESET 842, 844, 846, 848).

In some aspects, at 1112, the UE may perform a group-wise PDCCH pruning process to detect an absence of PDCCH (or PDCCH DMRS absence) for the group of UEs based on a sharing of the DMRS REs among the group of UEs. For example, referring to FIG. 9, the UE 902 may, at 920, perform a group-wise PDCCH pruning process to detect an absence of PDCCH (or PDCCH DMRS absence) for the group of UEs based on a sharing of the DMRS REs among the group of UEs. In some aspects, 1112 may be performed by the DMRS component 198.

In some aspects, at 1114, the UE may perform a group-wise PDCCH pruning process to detect an absence of PDCCH (or PDCCH DMRS absence) for the group of UEs when the precoder granularity is a first precoder granularity. The first precoder granularity may include all continuous RBs in the corresponding sub-CORESET. For example, referring to FIG. 9, the UE 902 may, at 922, perform a group-wise PDCCH pruning process to detect an absence of PDCCH (or PDCCH DMRS absence) for the group of UEs when the precoder granularity is a first precoder granularity. The first precoder granularity may include all continuous RBs in the sub-CORESET (e.g., “allContiguousRBs_subCORESET”). In some aspects, 1114 may be performed by the DMRS component 198.

In some aspects, at 1116, the UE may perform a PDCCH pruning process for the UE to detect an absence of PDCCH (or PDCCH DMRS absence) for the UE when the precoder granularity is a second precoder granularity. The second precoder granularity may include the size of a REG bundle. For example, referring to FIG. 9, the UE 902 may, at 924, perform a PDCCH pruning process for the UE to detect an absence of PDCCH (or PDCCH DMRS absence) for the UE when the precoder granularity is a second precoder granularity. The second precoder granularity may include the size of a REG bundle (e.g., “sameAsREG-bundle”). In some aspects, 1116 may be performed by the DMRS component 198.

In some aspects, the UE may perform the PDCCH pruning process for the UE to detect the absence of PDCCH (or PDCCH DMRS absence) for the UE (e.g., at 1116) when the aggregation level is larger than an aggregation threshold. For example, referring to FIG. 9, the UE 902 may, at 924, perform the PDCCH pruning process for the UE to detect the absence of PDCCH (or PDCCH DMRS absence) for the UE when the aggregation level is larger than an aggregation threshold.

In some aspects, at 1118, the UE may skip a blind decoding process for the PDCCH based on the absence of the PDCCH (or PDCCH absence). For example, referring to FIG. 9, the UE 902 may, at 926, skip a blind decoding process for the PDCCH based on the absence of the PDCCH (or PDCCH DMRS absence). In some aspects, 1118 may be performed by the DMRS component 198.

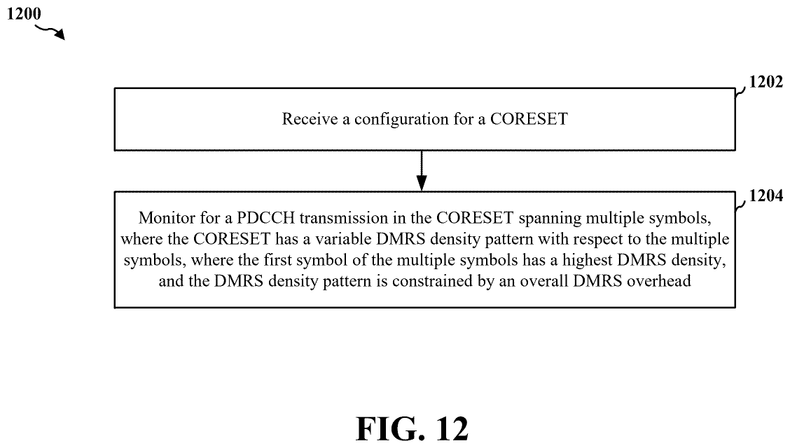

FIG. 12 is a flowchart 1200 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 804, 904; or the network entity 1602 in the hardware implementation of FIG. 16). The UE may be the UE 104, 350, 802, 902, or the apparatus 1604 in the hardware implementation of FIG. 16. By front-loading the DMRS on the first symbol of the CORESET, the methods allow UEs to detect the absence of control channels earlier in the processing pipeline, thereby conserving processing power that would otherwise be spent on unnecessary processes (e.g., decoding processes). Additionally, by adjusting the DMRS density based on the number of OFDM symbols or the minimum aggregation level in the CORESET, the methods provide flexibility to adapt to varying network conditions and UE capabilities. In some examples, by front-loading the DMRS in multiple sub-CORESETs in a CORESET, the methods enable dynamic rate matching and group-wise PDCCH pruning, thereby improving the resource utilization efficiency and reducing the computational burdens on UEs.

As shown at 1202, the UE may receive a configuration for a CORESET. The CORESET configuration may indicate time and/or frequency resources for the UE to monitor for PDCCH transmissions from a network entity. In some aspects, 1202 may be performed by the DMRS component 198.

As shown in FIG. 12, at 1204, the UE may monitor for a PDCCH transmission in a CORESET that spans (or includes) multiple symbols. The CORESET may have a variable DMRS density pattern with respect to the multiple symbols. The first symbol of the multiple symbols may have the highest DMRS density, and the DMRS density pattern may be constrained by an overall DMRS overhead. FIG. 5A, FIG. 5B, FIG. 6, FIG. 7, FIG. 8, and FIG. 9 illustrate various aspects of the steps in connection with flowchart 1200. For example, referring to FIG. 9, the UE 902 may receive, at 916, from a network entity (base station 904), a CORESET that spans (or includes) multiple OFDM symbols. Referring to FIG. 7, the CORESET may have a variable DMRS density pattern with respect to the multiple OFDM symbols. For example, in diagram 700, the CORESET may include two symbols: b₁ 702 and b₂ 712. The first symbol (e.g., b₁ 702) may have the highest DMRS density (e.g., 5/12), and the second symbol (e.g., b₂ 712) may have a different and lower DMRS density (e.g., 1/12). As another example, in diagram 720, the CORESET may include three symbols: b₁ 722, b₂ 732, and b₃ 742. The first symbol (e.g., b₁ 722) may have the highest DMRS density (e.g., 4/9), and the second symbol (e.g., b₂ 732) and the third symbol (e.g., b₃ 742) may each have a different and lower DMRS density (e.g., 5/36 and ⅙, respectively). In some aspects, 1204 may be performed by the DMRS component 198.

In some aspects, the UE may communicate with the network entity based on a PDCCH transmission received in the CORESET. For example, referring to FIG. 9, the UE 902 may, at 928, communicate with the network entity (e.g., base station 904) based on the CORESET.

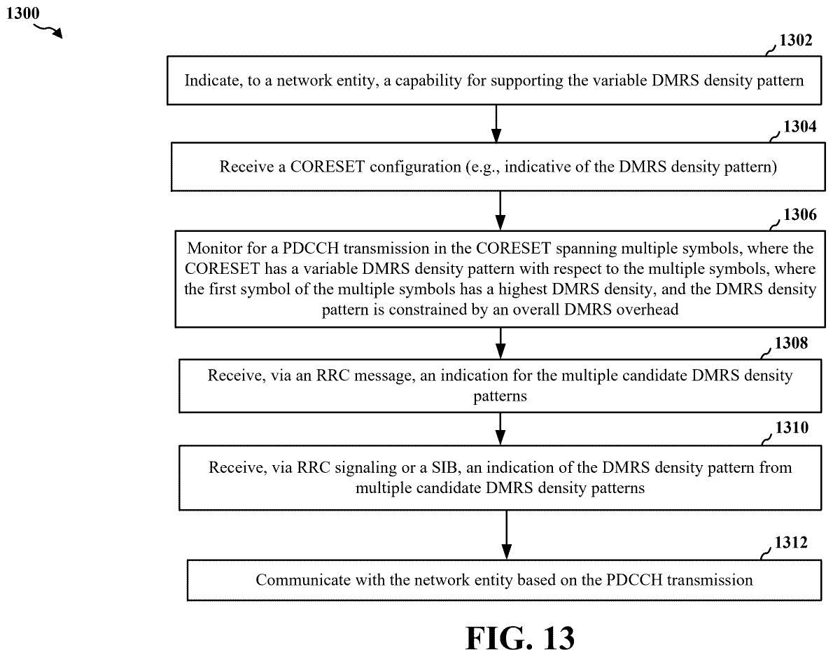

FIG. 13 is a flowchart 1300 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 804, 904; or the network entity 1602 in the hardware implementation of FIG. 16). The UE may be the UE 104, 350, 802, 902, or the apparatus 1604 in the hardware implementation of FIG. 16. By front-loading the DMRS on the first symbol of the CORESET, the methods allow UEs to detect the absence of control channels earlier in the processing pipeline, thereby conserving processing power that would otherwise be spent on unnecessary processes (e.g., decoding processes). Additionally, by adjusting the DMRS density based on the number of OFDM symbols or the minimum aggregation level in the CORESET, the methods provide flexibility to adapt to varying network conditions and UE capabilities. In some examples, by front-loading the DMRS in multiple sub-CORESETs in a CORESET, the methods enable dynamic rate matching and group-wise PDCCH pruning, thereby improving the resource utilization efficiency and reducing the computational burdens on UEs.

As shown at 1304, the UE may receive a configuration for a CORESET. The CORESET configuration may indicate time and/or frequency resources for the UE to monitor for PDCCH transmissions from a network entity. In some aspects, 1304 may be performed by the DMRS component 198.

As shown in FIG. 13, at 1306, the UE may monitor for a PDCCH transmission in the CORESET that spans (or includes) multiple symbols. The CORESET may have a variable DMRS density pattern with respect to the multiple symbols. The first symbol of the multiple symbols may have the highest DMRS density, and the DMRS density pattern may be constrained by an overall DMRS overhead. FIG. 5A, FIG. 5B, FIG. 6, FIG. 7, FIG. 8, and FIG. 9 illustrate various aspects of the steps in connection with flowchart 1300. For example, referring to FIG. 9, the UE 902 may receive, at 916, from a network entity (base station 904), a CORESET that spans (or includes) multiple OFDM symbols. Referring to FIG. 7, the CORESET may have a variable DMRS density pattern with respect to the multiple OFDM symbols. For example, in diagram 700, the CORESET may include two symbols: b₁ 702 and b₂ 712. The first symbol (e.g., b₁ 702) may have the highest DMRS density (e.g., 5/12), and the second symbol (e.g., b₂ 712) may have a different and lower DMRS density (e.g., 1/12). As another example, in diagram 720, the CORESET may include three symbols: b₁ 722, b₂ 732, and b₃ 742. The first symbol (e.g., b₁ 722) may have the highest DMRS density (e.g., 4/9), and the second symbol (e.g., b₂ 732) and the third symbol (e.g., b₃ 742) may each have a different and lower DMRS density (e.g., 5/36 and ⅙, respectively). In some aspects, 1306 may be performed by the DMRS component 198.

As shown in FIG. 13, at 1312, the UE may communicate with the network entity based on the PDCCH transmission in the CORESET. For example, referring to FIG. 9, the UE 902 may, at 928, communicate with the network entity (e.g., base station 904) based on the CORESET. In some aspects, 1312 may be performed by the DMRS component 198.

In some aspects, the variable DMRS density pattern may be determined based on one or more of: the number of symbols in the CORESET, the minimum aggregation level for the DMRS REs, a highest Doppler effect among all served UEs of the network entity, or the worst link quality among the served UEs. For example, referring to FIG. 9, when the base station 904 determines the DMRS density pattern at 908, the DMRS density pattern may be determined based on one or more of: the number of OFDM symbols in the CORESET, the minimum aggregation level for the DMRS REs, a highest Doppler effect among all served UEs of the network entity, or the worst link quality among the served UEs.

In some aspects, at 1304, the configuration may be indicative of the DMRS density pattern. For example, referring to FIG. 9, at 918, the UE 902 may receive a CORESET configuration indicative of the DMRS density pattern. In some aspects, 1304 may be performed by the DMRS component 198.

In some aspects, at 1308, the UE may receive from the network entity via an RRC message, an indication for the multiple candidate DMRS density patterns. At 1310, the UE may receive from the network entity, via RRC signaling or a SIB, an indication of the DMRS density pattern from multiple candidate DMRS density patterns. For example, referring to FIG. 9, at 918, the UE 902 may receive multiple indications for the DMRS density pattern. For example, the UE 902 may first receive from base station 904, via an RRC message, one indication for the multiple candidate DMRS density patterns. Subsequently, the UE 902 may further receive from base station 904, via RRC signaling or an SIB, another indication of the DMRS density pattern from the multiple candidate DMRS density patterns. In some aspects, 1308 and 1310 may be performed by the DMRS component 198.

In some aspects, at 1302, the UE may indicate to the network entity the capability for supporting the variable DMRS density pattern. For example, referring to FIG. 9, the UE 902 may, at 906, indicate to the network entity (e.g., base station 904) the capability for supporting the variable DMRS density pattern. In some aspects, 1302 may be performed by the DMRS component 198.

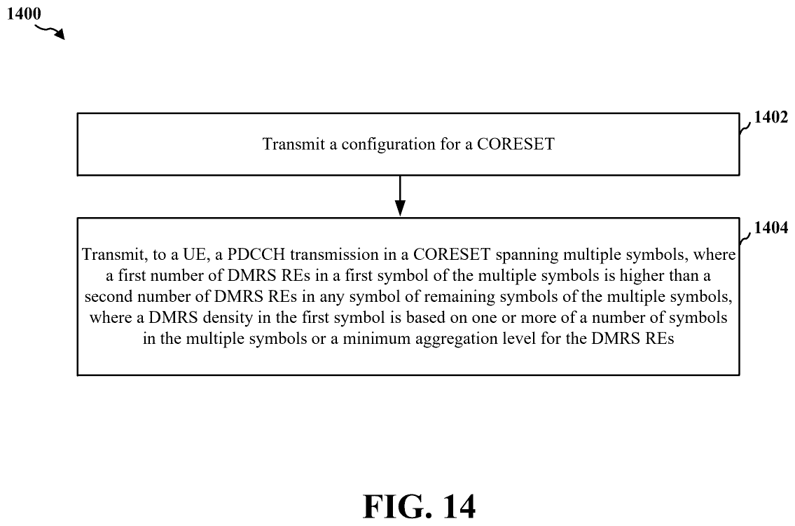

FIG. 14 is a flowchart 1400 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 804, 904; or the network entity 1602 in the hardware implementation of FIG. 16). The UE may be the UE 104, 350, 802, 902, or the apparatus 1604 in the hardware implementation of FIG. 16. By front-loading the DMRS on the first symbol of the CORESET, the methods allow UEs to detect the absence of control channels earlier in the processing pipeline, thereby conserving processing power that would otherwise be spent on unnecessary processes (e.g., decoding processes). Additionally, by adjusting the DMRS density based on the number of OFDM symbols or the minimum aggregation level in the CORESET, the methods provide flexibility to adapt to varying network conditions and UE capabilities. In some examples, by front-loading the DMRS in multiple sub-CORESETs in a CORESET, the methods enable dynamic rate matching and group-wise PDCCH pruning, thereby improving the resource utilization efficiency and reducing the computational burdens on UEs.

As shown at 1402, the network entity may transmit a configuration for a CORESET. The CORESET configuration may indicate time and/or frequency resources for the UE to monitor for PDCCH transmissions from a network entity. In some aspects, 1402 may be performed by the DMRS component 199.

As shown in FIG. 14, at 1404 the network entity may transmit a PDCCH transmission to a UE in the CORESET. The CORESET may span (or include) multiple symbols. The first number of DMRS REs in the first symbol of the multiple symbols may be higher than a second number of DMRS REs in any symbol of the remaining symbols in the multiple symbols. The DMRS density in the first symbol may be based on the number of symbols in the multiple symbols or the minimum aggregation level for the DMRS REs. FIG. 5A, FIG. 5B, FIG. 6, FIG. 7, FIG. 8, and FIG. 9 illustrate various aspects of the steps in connection with flowchart 1400. For example, referring to FIG. 9, the network entity (e.g., base station 904) may, at 916, transmit a CORESET to the UE 902. Referring to FIG. 8, the CORESET 850 may span (or include) multiple (e.g., six) OFDM symbols. The first number of DMRS REs in the first OFDM symbol 812 in the multiple OFDM symbols may be higher than a second number of DMRS REs in any OFDM symbol of the remaining OFDM symbols (e.g., symbol 814, 816, 818, 820, 822) in the multiple OFDM symbols. The DMRS density (e.g., ½) in the first OFDM symbol (e.g., symbol 812) may be based on the number of OFDM symbols in the multiple OFDM symbols or the minimum aggregation level for the DMRS REs. In some aspects, 1404 may be performed by the DMRS component 199.

In some aspects, the network entity may communicate with the UE based on the CORESET. For example, referring to FIG. 9, the network entity (e.g., base station 904) may, at 928, communicate with the UE 902 based on the CORESET.

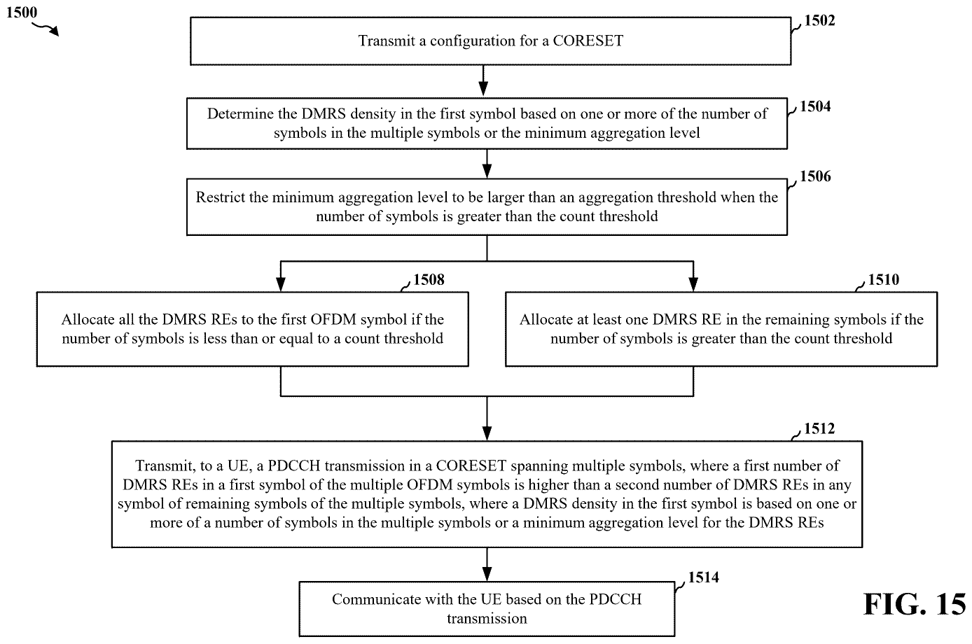

FIG. 15 is a flowchart 1500 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 804, 904; or the network entity 1602 in the hardware implementation of FIG. 16). The UE may be the UE 104, 350, 802, 902, or the apparatus 1604 in the hardware implementation of FIG. 16. By front-loading the DMRS on the first symbol of the CORESET, the methods allow UEs to detect the absence of control channels earlier in the processing pipeline, thereby conserving processing power that would otherwise be spent on unnecessary processes (e.g., decoding processes). Additionally, by adjusting the DMRS density based on the number of OFDM symbols or the minimum aggregation level in the CORESET, the methods provide flexibility to adapt to varying network conditions and UE capabilities. In some examples, by front-loading the DMRS in multiple sub-CORESETs in a CORESET, the methods enable dynamic rate matching and group-wise PDCCH pruning, thereby improving the resource utilization efficiency and reducing the computational burdens on UEs.

As shown at 1502, the network entity may transmit a configuration for a CORESET. The CORESET configuration may indicate time and/or frequency resources for the UE to monitor for PDCCH transmissions from a network entity. In some aspects, 1502 may be performed by the DMRS component 199.

As shown in FIG. 15, at 1512, the network entity may transmit a PDCCH transmission to the UE in the CORESET. The CORESET may span (or include) multiple symbols (e.g., OFDM symbols). The first number of DMRS REs in the first symbol of the multiple symbols may be higher than a second number of DMRS REs in any symbol of the remaining symbols in the multiple symbols. The DMRS density in the first symbol may be based on the number of symbols in the multiple symbols or the minimum aggregation level for the DMRS REs. FIG. 5A, FIG. 5B, FIG. 6, FIG. 7, FIG. 8, and FIG. 9 illustrate various aspects of the steps in connection with flowchart 1500. For example, referring to FIG. 9, the network entity (e.g., base station 904) may, at 916, transmit a CORESET to the UE 902. Referring to FIG. 8, the CORESET 850 may span (or include) multiple (e.g., six) OFDM symbols. The first number of DMRS REs in the first OFDM symbol 812 in the multiple OFDM symbols may be higher than a second number of DMRS REs in any OFDM symbol of the remaining OFDM symbols (e.g., symbol 814, 816, 818, 820, 822) in the multiple OFDM symbols. The DMRS density (e.g., ½) in the first OFDM symbol (e.g., symbol 812) may be based on the number of OFDM symbols in the multiple OFDM symbols or the minimum aggregation level for the DMRS REs. In some aspects 1512 may be performed by the DMRS component 199.

At 1514, the network entity may communicate with the UE based on the CORESET. For example, referring to FIG. 9, the network entity (e.g., base station 904) may, at 928, communicate with the UE 902 based on the PDCCH transmission in the CORESET. In some aspects, 1514 may be performed by DMRS component 199.

In some aspects, the DMRS density may include the ratio of the number of the DMRS REs to the total number of REs in a symbol, and all the REs in the first symbol may be the DMRS REs. For example, referring to FIG. 8, the DMRS density includes the ratio of a number of DMRS REs (e.g., RE 824) to the total number of REs in an OFDM symbol (e.g., symbol 812), and all the REs in the first OFDM symbol may be the DMRS REs.

In some aspects, the remaining symbols do not include any DMRS RE. For example, referring to FIG. 5A, when the number of symbols in a CORESET is small (e.g., less than the count threshold), the remaining OFDM symbols (e.g., symbol 504) do not include any DMRS RE.

In some aspects, at 1504, the network entity may determine the DMRS density in the first symbol based on the number of symbols in the multiple symbols or the minimum aggregation level. For example, referring to FIG. 9, the network entity (e.g., base station 904) may, at 908, determine the DMRS density in the first OFDM symbol based on the number of OFDM symbols in the multiple OFDM symbols or the minimum aggregation level. In some aspects, 1504 may be performed by DMRS component 199.

In some aspects, at 1508, the network entity may allocate all the DMRS REs to the first symbol when the number of symbols is less than or equal to a count threshold. In some aspects, at 1510, the network entity may allocate at least one DMRS RE in the remaining symbols when the number of symbols is greater than the count threshold. For example, referring to FIG. 9, the network entity (e.g., base station 904) may, at 912, allocate all the DMRS REs to the first OFDM symbol when the number of OFDM symbols is less than or equal to a count threshold. At 912, the network entity (e.g., base station 904) may allocate at least one DMRS RE in the remaining OFDM symbols when the number of OFDM symbols is greater than the count threshold. Referring to FIG. 5A and FIG. 8, if the number of OFDM symbols (e.g., two) is less than or equal to a count threshold (e.g., N=3), all the DMRS REs may be in the first OFDM symbol 502. Otherwise, if the number of OFDM symbols (e.g., six) is greater than the count threshold (e.g., N=3), at least one DMRS RE may be in the remaining OFDM symbols (e.g., symbol 822). In some aspects, 1508 and 1510 may be performed by DMRS component 199.

In some aspects, when allocating the at least one DMRS RE in the remaining symbols (e.g., at 1510), the network entity may allocate the at least one DMRS RE in the remaining symbols based on a configuration that indicates the presence of the DMRS RE in the remaining symbols. For example, referring to FIG. 9, the network entity (e.g., base station 904) may, at 914, allocate the at least one DMRS RE in the remaining OFDM symbols based on a configuration that indicates the presence of the DMRS RE in the remaining OFDM symbols.

In some aspects, at 1506, the network entity may restrict the minimum aggregation level to be larger than an aggregation threshold when the number of symbols is greater than the count threshold, and the aggregation level may include the number of REG associated with a PDCCH candidate. For example, referring to FIG. 9, the network entity (e.g., base station 904) may, at 910, restrict the minimum aggregation level to be larger than an aggregation threshold when the number of OFDM symbols is greater than the count threshold, and the aggregation level may include the number of REG associated with a PDCCH candidate. In some aspects, 1506 may be performed by DMRS component 199.

In some aspects, the number of symbols may be greater than the count threshold, and the last OFDM symbol in the multiple OFDM symbols includes a third number of DMRS REs. The third number is larger than the number of DMRS REs in any other symbols in the multiple symbols except for the first symbol and the last symbol. For example, referring to FIG. 8, the last OFDM symbol 822 in the multiple OFDM symbols includes a third number of DMRS REs, and the third number is larger than a number of DMRS REs in any other OFDM symbols in the multiple OFDM symbols except for the first OFDM symbol and the last OFDM symbol, such as symbol 814, 816, 818, 820.

In some aspects, the first number is greater than the third number. For example, referring to FIG. 8, the first number of DMRS REs in symbol 812 is greater than the third number of DMRS REs in symbol 822.

In some aspects, the CORESET may span (or include) multiple sub-CORESETs in a frequency domain. Each sub-CORESET may have a DMRS RE if a REG in the sub-CORESET carries PDCCH. For each sub-CORESET, the fourth number of DMRS REs in the first symbol of the multiple symbols is higher than a fifth number of DMRS REs in any symbol of the remaining symbols in the multiple symbols. For example, referring to FIG. 6, the CORESET 610 may include multiple sub-CORESETs (e.g., sub-CORESET 612, 614, 616, 618) in a frequency domain, and each sub-CORESET may have a DMRS RE if the REG in the sub-CORESET carries PDCCH. For each sub-CORESET (e.g., sub-CORESET 612, 614, 616, 618), a fourth number of DMRS REs (e.g., DMRS 622, 624, 626, 628) in the first OFDM symbol in the multiple OFDM symbols is higher than a fifth number of DMRS REs for any OFDM symbol of the remaining OFDM symbols in the multiple OFDM symbols.

In some aspects, each sub-CORESET may respectively correspond to different precoder granularities. For example, referring to FIG. 8, each sub-CORESET (e.g., sub-CORESET 842, 844, 846, 848) may respectively correspond to different precoder granularities (e.g., when the precoder granularity for PDCCH is set at “allContiguousRBs_subCORESET”).

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor (or processing circuitry) 1624 (also referred to as a modem) coupled to one or more transceivers 1622 (e.g., cellular RF transceiver). The cellular baseband processor(s) (or processing circuitry) 1624 may include at least one on-chip memory (or memory circuitry) 1624′. In some aspects, the apparatus 1604 may further include one or more subscriber identity modules (SIM) cards 1620 and at least one application processor (or processing circuitry) 1606 coupled to a secure digital (SD) card 1608 and a screen 1610. The application processor(s) (or processing circuitry) 1606 may include on-chip memory (or memory circuitry) 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) (or processing circuitry) 1624 communicates through the transceiver(s) 1622 via one or more antennas 1680 with the UE 104 and/or with an RU associated with a network entity 1602. The cellular baseband processor(s) (or processing circuitry) 1624 and the application processor(s) (or processing circuitry) 1606 may each include a computer-readable medium/memory (or memory circuitry) 1624′, 1606′, respectively. The additional memory modules 1626 may also be considered a computer-readable medium/memory (or memory circuitry). Each computer-readable medium/memory (or memory circuitry) 1624′, 1606′, 1626 may be non-transitory. The cellular baseband processor(s) (or processing circuitry) 1624 and the application processor(s) (or processing circuitry) 1606 are each responsible for general processing, including the execution of software stored on the computer-readable medium/memory (or memory circuitry). The software, when executed by the cellular baseband processor(s) (or processing circuitry) 1624/application processor(s) (or processing circuitry) 1606, causes the cellular baseband processor(s) (or processing circuitry) 1624/application processor(s) (or processing circuitry) 1606 to perform the various functions described supra. The cellular baseband processor(s) (or processing circuitry) 1624 and the application processor(s) (or processing circuitry) 1606 are configured to perform the various functions described supra based at least in part of the information stored in the memory (or memory circuitry). That is, the cellular baseband processor(s) (or processing circuitry) 1624 and the application processor(s) (or processing circuitry) 1606 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1624/application processor(s) (or processing circuitry) 1606 when executing software. The cellular baseband processor(s) (or processing circuitry) 1624/application processor(s) (or processing circuitry) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) (or processing circuitry) 1624 and/or the application processor(s) (or processing circuitry) 1606, and in another configuration, the apparatus 1604 may be the entire UE (e.g., see UE 350 of FIG. 3) and include the additional modules of the apparatus 1604.

As discussed supra, the component 198 may be configured to receive a configuration for a CORESET; and monitor for a PDCCH transmission in the CORESET including multiple symbols from a network entity, where a first number of DMRS REs in a first symbol of the multiple symbols is higher than a second number of DMRS REs in any symbol of the remaining symbols in the multiple symbols, where a DMRS density in the first symbol is based on one or more of a number of symbols in the multiple symbols or a minimum aggregation level for the DMRS REs. The component may be further configured to communicate with the network entity based on the PDCCH transmission in the CORESET. The component 198 may be further configured to perform any of the aspects described in connection with the flowcharts in FIG. 10, FIG. 11, FIG. 12, and FIG. 13, and/or performed by the UE 902 in FIG. 9. The component 198 may be within the cellular baseband processor(s) (or processing circuitry) 1624, the application processor(s) (or processing circuitry) 1606, or both the cellular baseband processor(s) (or processing circuitry) 1624 and the application processor(s) (or processing circuitry) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) (or processing circuitry) 1624 and/or the application processor(s) (or processing circuitry) 1606, includes means for receiving configuration for a CORESET; and monitoring for a PDCCH transmission in the a CORESET including multiple symbols from a network entity, where a first number of DMRS REs in a first symbol of the multiple symbols is higher than a second number of DMRS REs in any symbol of the remaining symbols in the multiple symbols, where a DMRS density in the first symbol is based on one or more of a number of symbols in the multiple symbols or a minimum aggregation level for the DMRS REs. The apparatus may further include means for communicating with the network entity based on the CORESET. The apparatus 1604 may further include means for performing any of the aspects described in connection with the flowcharts in FIG. 10 and FIG. 11, FIG. 12, and FIG. 13, and/or aspects performed by the UE 902 in FIG. 9. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

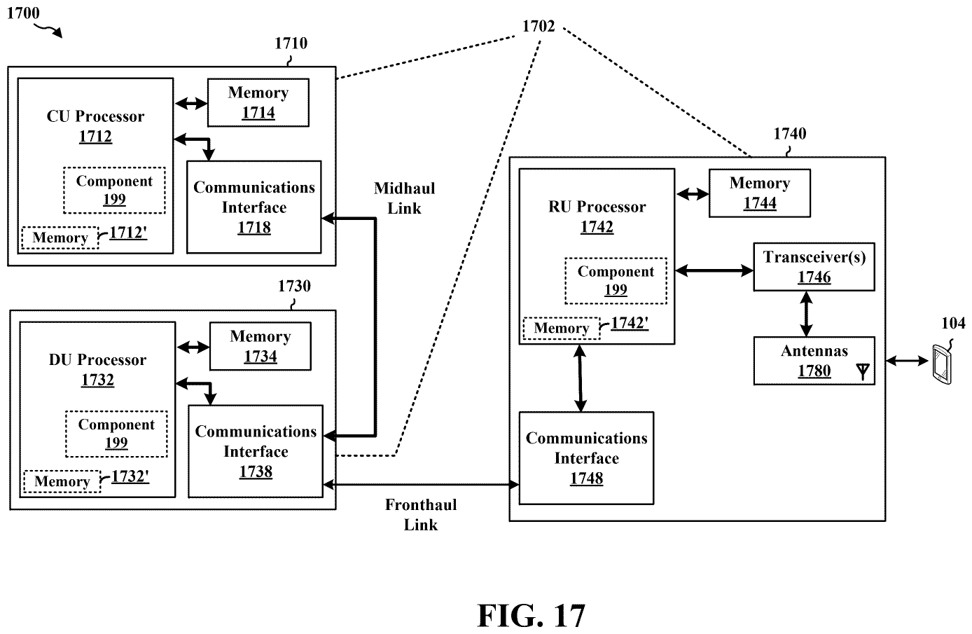

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor (or processing circuitry) 1712. The CU processor(s) (or processing circuitry) 1712 may include on-chip memory (or memory circuitry) 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor (or processing circuitry) 1732. The DU processor(s) (or processing circuitry) 1732 may include on-chip memory (or memory circuitry) 1732′. In some aspects, the DU 1730 may further include additional memory modules 1734 and a communications interface 1738. The DU 1730 communicates with the RU 1740 through a fronthaul link. The RU 1740 may include at least one RU processor (or processing circuitry) 1742. The RU processor(s) (or processing circuitry) 1742 may include on-chip memory (or memory circuitry) 1742′. In some aspects, the RU 1740 may further include additional memory modules 1744, one or more transceivers 1746, antennas 1780, and a communications interface 1748. The RU 1740 communicates with the UE 104. The on-chip memory (or memory circuitry) 1712′, 1732′, 1742′ and the additional memory modules 1714, 1734, 1744 may each be considered a computer-readable medium/memory (or memory circuitry). Each computer-readable medium/memory (or memory circuitry) may be non-transitory. Each of the processors (or processing circuitry) 1712, 1732, 1742 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit a configuration for a CORESET and transmit a PDCCH transmission in the CORESET including multiple symbols to a UE, where a first number of DMRS REs in a first symbol of the multiple symbols is higher than a second number of DMRS REs in any symbol of the remaining symbols in the multiple symbols, where a DMRS density in the first symbol is based on one or more of a number of symbols in the multiple symbols or a minimum aggregation level for the DMRS REs. The component 199 may be further configured to communicate with the UE based on the CORESET. The component 199 may be further configured to perform any of the aspects described in connection with the flowcharts in FIG. 14 and FIG. 15, and/or performed by the base station 904 in FIG. 9. The component 199 may be within one or more processors (or processing circuitry) of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 includes means for transmitting a configuration for a CORESET and means for transmitting a PDCCH transmission in the CORESET including multiple symbols to a UE, where a first number of DMRS REs in a first symbol of the multiple symbols is higher than a second number of DMRS REs in any symbol of the remaining symbols in the multiple symbols, where a DMRS density in the first symbol is based on one or more of a number of symbols in the multiple symbols or a minimum aggregation level for the DMRS REs. The network entity may further include means for communicating with the UE based on the CORESET. The network entity 1702 may further include means for performing any of the aspects described in connection with the flowcharts in FIG. 14 and FIG. 15, and/or aspects performed by the base station 904 in FIG. 9. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving a configuration for a CORESET and monitoring for PDCCH transmissions from a network entity in the CORESET. The CORESET may include multiple symbols. The first number of DMRS REs in the first symbol of the multiple symbols is higher than the second number of DMRS REs in any symbol of the remaining symbols in the multiple symbols, and the DMRS density in the first symbol is based on the number of symbols in the multiple symbols or the minimum aggregation level for the DMRS REs. The method may further include communicating with the network entity based on the CORESET. By front-loading the DMRS on the first symbol of the CORESET, the methods allow UEs to detect the absence of control channels earlier in the processing pipeline, thereby conserving processing power that would otherwise be spent on unnecessary processes (e.g., decoding processes). Additionally, by adjusting the DMRS density based on the number of symbols or the minimum aggregation level in the CORESET, the methods provide flexibility to adapt to varying network conditions and UE capabilities. In some examples, by front-loading the DMRS in multiple sub-CORESETs in a CORESET, the methods enable dynamic rate matching and group-wise PDCCH pruning, thereby improving the resource utilization efficiency and reducing the computational burdens on UEs.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving a configuration for a control resource set (CORESET); and monitoring for a physical downlink control channel (PDCCH) transmission in the CORESET spanning multiple symbols, wherein a first number of demodulation reference signal (DMRS) resource elements (REs) in a first symbol of the multiple symbols is higher than a second number of DMRS REs in any symbol of remaining symbols in the multiple symbols, wherein a DMRS density in the first symbol is based on one or more of a number of symbols in the multiple symbols or a minimum aggregation level for the DMRS REs.

Aspect 2 is the method of aspect 1, wherein the DMRS density includes a ratio of a number of the DMRS REs to a total number of REs in a symbol, and wherein all the REs in the first symbol are the DMRS REs.

Aspect 3 is the method of aspect 2, wherein the remaining symbols do not include any DMRS RE.

Aspect 4 is the method of any of aspects 1 to 3, wherein the number of symbols is less than or equal to a count threshold, all the DMRS REs are in the first symbol.

Aspect 5 is the method of any of aspects 1 to 3, wherein the number of symbols is greater than the count threshold, and at least one DMRS RE is in the remaining symbols.

Aspect 6 is the method of any of aspects 4 to 5, wherein the count threshold is three.

Aspect 7 is the method of aspect 5, wherein a presence of the DMRS RE in the remaining symbols is based on a DMRS configuration indicative of the presence of the DMRS RE in the remaining symbols.

Aspect 8 is the method of aspect 5, wherein the minimum aggregation level is larger than an aggregation threshold, and wherein the aggregation level includes a number of resource element group (REG) associated with a PDCCH candidate.

Aspect 9 is the method of aspect 5, wherein a last symbol in the multiple symbols includes a third number of DMRS REs, wherein the third number of DMRS REs is larger than a number of DMRS REs in any other symbols in the multiple symbols except for the first symbol and the last symbol.

Aspect 10 is the method of aspect 9, where the first number of DMRS REs is greater than the third number of DMRS REs.

Aspect 11 is the method of any of aspects 1 to 10, wherein the CORESET comprises multiple sub-CORESETs in a frequency domain, each sub-CORESET having DMRS RE if a resource element group (REG) in the sub-CORESET carries the PDCCH transmission, and wherein, for each sub-CORESET, a fourth number of DMRS REs in the first symbol of the multiple symbols is higher than a fifth number of DMRS REs in any symbol of the remaining symbols in the multiple symbols.

Aspect 12 is the method of aspect 11, wherein each sub-CORESET respectively corresponds to different precoder granularities.

Aspect 13 is the method of aspect 11, wherein the UE is a first UE, and wherein the DMRS REs are shared among a group of UEs comprising the first UE and a second UE based on the multiple sub-CORESETs.

Aspect 14 is the method of aspect 13, where the method further includes performing a group-wise PDCCH pruning process to detect a PDCCH DMRS absence for the group of UEs based on a sharing of the DMRS REs among the group of UEs.

Aspect 15 is the method of aspect 13, where the method further includes performing, in response to a precoder granularity being a first precoder granularity, a group-wise PDCCH pruning process to detect a PDCCH DMRS absence for the group of UEs, wherein the first precoder granularity includes all continuous resource blocks (RBs) in a corresponding sub-CORESET.

Aspect 16 is the method of aspect 13, where the method further includes performing, in response to a precoder granularity being a second precoder granularity, a PDCCH pruning process for the UE to detect a PDCCH DMRS absence for the UE, wherein the second precoder granularity includes a size of a resource element group (REG) bundle.

Aspect 17 is the method of aspect 16, wherein performing the PDCCH pruning process for the UE includes performing, in response to an aggregation level being larger than an aggregation threshold, the PDCCH pruning process for the UE.

Aspect 18 is the method of aspect 17, where the method further includes skipping a blind decoding process for the PDCCH transmission based on the PDCCH DMRS absence.

Aspect 19 is an apparatus for wireless communication at a UE, comprising: a processing system that includes processor circuitry and memory circuitry that stores code and is coupled with the processor circuitry, the processing system configured to cause the UE to perform the method of one or more of aspects 1-18.

Aspect 20 is an apparatus for wireless communication at a UE, comprising: at least one memory; and at least one processor coupled to the at least one memory and, where the at least one processor, individually or in any combination, is configured to perform the method of any of aspects 1-18.

Aspect 21 is the apparatus for wireless communication at a UE, comprising means for performing each step in the method of any of aspects 1-18.

Aspect 22 is an apparatus of any of aspects 19-21, further comprising a transceiver configured to receive or to transmit in association with the method of any of aspects 1-18.

Aspect 23 is a computer-readable medium (e.g., a non-transitory computer-readable medium) storing computer executable code at a UE, the code when executed by at least one processor causes the at least one processor to, individually or in any combination, perform the method of any of aspects 1-18.

Aspect 24 is a method of wireless communication at a UE. The method includes receiving a configuration for a control resource set (CORESET); and monitoring for a physical downlink control channel (PDCCH) transmission in the CORESET spanning multiple symbols, wherein the CORESET has a variable demodulation reference signal (DMRS) density pattern with respect to the multiple symbols, wherein the first symbol of the multiple symbols has a highest DMRS density among the multipole symbols, and the DMRS density pattern is constrained by an overall DMRS overhead.

Aspect 25 is the method of aspect 24, wherein the variable DMRS density pattern is determined based on one or more of: the number of symbols in the CORESET, the minimum aggregation level for the DMRS resource elements (REs), the highest Doppler effect among all served UEs of a network entity, or the worst link quality among the served UEs.

Aspect 26 is the method of any of aspects 24 to 25, wherein the configuration is indicative of a DMRS density pattern.

Aspect 27 is the method of any of aspects 24 to 25, where the method further includes receiving, from the network entity, via radio resource control (RRC) signaling or a system information block (SIB), a first indication of the DMRS density pattern from multiple candidate DMRS density patterns.

Aspect 28 is the method of aspect 27, where the method further includes receiving, from the network entity, via an RRC message, a second indication for the multiple candidate DMRS density patterns.

Aspect 29 is the method of any of aspects 24 to 28, where the method further includes indicating, to the network entity, a capability for supporting the variable DMRS density pattern.

Aspect 30 is an apparatus for wireless communication at a UE, comprising: a processing system that includes processor circuitry and memory circuitry that stores code and is coupled with the processor circuitry, the processing system configured to cause the UE to perform the method of one or more of aspects 24-29.

Aspect 31 is an apparatus for wireless communication at a UE, comprising: at least one memory; and at least one processor coupled to the at least one memory and, where the at least one processor, individually or in any combination, is configured to perform the method of any of aspects 24-29.

Aspect 32 is the apparatus for wireless communication at a UE, comprising means for performing each step in the method of any of aspects 24-29.

Aspect 33 is an apparatus of any of aspects 30-32, further comprising a transceiver configured to receive or to transmit in association with the method of any of aspects 24-29.

Aspect 34 is a computer-readable medium (e.g., a non-transitory computer-readable medium) storing computer executable code at a UE, the code when executed by at least one processor causes the at least one processor to, individually or in any combination, perform the method of any of aspects 24-29.

Aspect 35 is a method of wireless communication at a network entity. The method includes transmitting a configuration for a control resource set (CORESET); and transmitting, to a user equipment (UE), a physical downlink control channel (PDCCH) transmission in a control resource set (CORESET) spanning multiple symbols, wherein a first number of demodulation reference signal (DMRS) resource elements (REs) in a first symbol of the multiple symbols is higher than a second number of DMRS REs in any symbol of remaining symbols in the multiple symbols, wherein a DMRS density in the first symbol is based on one or more of a number of symbols in the multiple symbols or a minimum aggregation level for the DMRS REs. In some aspects, the network entity may further communicate with the UE based on the PDCCH transmission.

Aspect 36 is the method of aspect 35, wherein the DMRS density includes a ratio of a number of the DMRS REs to a total number of REs in a symbol, and wherein all the REs in the first symbol are the DMRS REs.

Aspect 37 is the method of aspect 36, wherein the remaining symbols do not include any DMRS RE.

Aspect 38 is the method of any of aspects 35 to 37, wherein the DMRS density in the first symbol based on one or more of the number of symbols in the multiple symbols or the minimum aggregation level.

Aspect 39 is the method of any of aspects 35 to 38, where the method further includes allocating, in response to the number of symbols being less than or equal to a count threshold, all the DMRS REs to the first symbol, or allocating, in response to the number of symbols being greater than the count threshold, at least one DMRS RE in the remaining symbols.

Aspect 40 is the method of aspect 39, wherein the count threshold is three.

Aspect 41 is the method of aspect 39, wherein allocating the at least one DMRS RE in the remaining symbols comprises: allocating, in response to a configuration indicative of a presence of the DMRS RE in the remaining symbols, the at least one DMRS RE in the remaining symbols.

Aspect 42 is the method of aspect 39, where the method further includes restricting, in response to the number of symbols being greater than the count threshold, the minimum aggregation level to be larger than an aggregation threshold, wherein the aggregation level includes a number of resource element group (REG) associated with a physical downlink control channel (PDCCH) candidate.

Aspect 43 is the method of aspect 39, wherein the number of symbols is greater than the count threshold, and wherein a last symbol in the multiple symbols includes a third number of DMRS REs, wherein the third number is larger than a number of DMRS RE in any other symbols in the multiple symbols except for the first symbol and the last symbol.

Aspect 44 is the method of aspect 43, where the first number is greater than the third number.

Aspect 45 is the method of aspect 39, wherein the CORESET comprises multiple sub-CORESETs in a frequency domain, each sub-CORESET having a DMRS RE if a resource element group (REG) in the sub-CORESET carries physical downlink control channel (PDCCH), and wherein, for each sub-CORESET, a fourth number of DMRS REs in the first symbol of the multiple symbols is higher than a fifth number of DMRS REs in any symbol of the remaining symbols in the multiple symbols.

Aspect 46 is the method of aspect 45, wherein each sub-CORESET respectively corresponds to different precoder granularities.

Aspect 47 is an apparatus for wireless communication at a network entity, comprising: a processing system that includes processor circuitry and memory circuitry that stores code and is coupled with the processor circuitry, the processing system configured to cause the network entity to perform the method of one or more of aspects 35-46.

Aspect 48 is an apparatus for wireless communication at a network entity, comprising: at least one memory; and at least one processor coupled to the at least one memory and, where the at least one processor, individually or in any combination, is configured to perform the method of any of aspects 35-46.

Aspect 49 is the apparatus for wireless communication at a network entity, comprising means for performing each step in the method of any of aspects 35-46.

Aspect 50 is an apparatus of any of aspects 36-38, further comprising a transceiver configured to receive or to transmit in association with the method of any of aspects 35-46.

Aspect 51 is a computer-readable medium (e.g., a non-transitory computer-readable medium) storing computer executable code at a network entity, the code when executed by at least one processor causes the at least one processor to, individually or in any combination, perform the method of any of aspects 35-46.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to cause the UE to:
receive a configuration for a control resource set (CORESET); and
monitor for a physical downlink control channel (PDCCH) transmission in the CORESET spanning multiple symbols, wherein a first number of demodulation reference signal (DMRS) resource elements (REs) in a first symbol of the multiple symbols is higher than a second number of DMRS REs in any symbol of remaining symbols in the multiple symbols, wherein a DMRS density in the first symbol is based on one or more of a number of symbols in the multiple symbols or a minimum aggregation level for DMRS REs.

2. The apparatus of claim 1, further comprising a transceiver coupled to the at least one processor, wherein to monitor for the PDCCH transmission, the at least one processor is configured to cause the UE to monitor the CORESET via the transceiver, wherein the DMRS density includes a ratio of a number of the DMRS REs to a total number of REs in a symbol, and wherein all the REs in the first symbol are the DMRS REs.

3. The apparatus of claim 2, wherein the remaining symbols do not include any DMRS RE.

4. The apparatus of claim 1, wherein the number of symbols is less than or equal to a count threshold, and all the DMRS REs are in the first symbol.

5. The apparatus of claim 1, wherein the number of symbols is greater than a count threshold, and at least one DMRS RE is in the remaining symbols.

6. The apparatus of claim 5, wherein a presence of a DMRS RE in the remaining symbols is based on a DMRS configuration indicative of the presence of the DMRS RE in the remaining symbols.

7. The apparatus of claim 5, wherein the minimum aggregation level is larger than an aggregation threshold, and wherein an aggregation level includes a number of resource element group (REG) associated with a PDCCH candidate.

8. The apparatus of claim 5, wherein a last symbol in the multiple symbols includes a third number of DMRS REs, wherein the third number of DMRS REs is larger than a number of DMRS REs in any other symbols in the multiple symbols except for the first symbol and the last symbol.

9. The apparatus of claim 8, wherein the first number of DMRS REs is greater than the third number of DMRS REs.

10. The apparatus of claim 1, wherein the CORESET comprises multiple sub-CORESETs in a frequency domain, each sub-CORESET having a DMRS RE if a resource element group (REG) in the sub-CORESET carries the PDCCH transmission, and wherein, for each sub-CORESET, a fourth number of DMRS REs in the first symbol of the multiple symbols is higher than a fifth number of DMRS REs in any symbol of the remaining symbols in the multiple symbols.

11. The apparatus of claim 10, wherein each sub-CORESET respectively corresponds to different precoder granularities.

12. The apparatus of claim 10, wherein the UE is a first UE, and wherein the DMRS REs are shared among a group of UEs comprising the first UE and a second UE based on the multiple sub-CORESETs.

13. The apparatus of claim 12, wherein the at least one processor is configured to cause the UE to:
perform a group-wise PDCCH pruning process to detect a PDCCH DMRS absence for the group of UEs based on a sharing of the DMRS REs among the group of UEs.

14. The apparatus of claim 12, wherein the at least one processor is configured to cause the UE to:
perform, in response to a precoder granularity being a first precoder granularity, a group-wise PDCCH pruning process to detect a PDCCH DMRS absence for the group of UEs, wherein the first precoder granularity includes all continuous resource blocks (RBs) in a corresponding sub-CORESET.

15. The apparatus of claim 12, wherein the at least one processor is configured to cause the UE to:
perform, in response to a precoder granularity being a second precoder granularity, a PDCCH pruning process for the UE to detect a PDCCH DMRS absence for the UE, wherein the second precoder granularity includes a size of a resource element group (REG) bundle.

16. The apparatus of claim 15, wherein to perform the PDCCH pruning process for the UE, the at least one processor is configured to cause the UE to:
perform, in response to an aggregation level being larger than an aggregation threshold, the PDCCH pruning process for the UE.

17. The apparatus of claim 15, wherein the at least one processor is configured to cause the UE to:
skip a blind decoding process for the PDCCH transmission based on the PDCCH DMRS absence.

18. An apparatus for wireless communication at a user equipment (UE), comprising:
at least one memory; and at least one processor coupled to the at least one memory and, based at least in part on information stored in the at least one memory, the at least one processor is configured to cause the UE to:
receive a configuration for a control resource set (CORESET); and
monitor for a physical downlink control channel (PDCCH) transmission in the CORESET spanning multiple symbols, wherein the CORESET has a variable demodulation reference signal (DMRS) density pattern with respect to the multiple symbols, wherein a first symbol of the multiple symbols has a highest DMRS density among the multiple symbols, and the variable DMRS density pattern is constrained by an overall DMRS overhead.

19. The apparatus of claim 18, further comprising a transceiver coupled to the at least one processor, wherein to monitor for the PDCCH transmission, the at least one processor is configured to cause the UE to monitor the CORESET via the transceiver, and wherein the variable DMRS density pattern is determined based on one or more of:
a number of symbols in the CORESET,
a minimum aggregation level for DMRS resource elements (REs),
a highest Doppler effect among all served UEs of a network entity, or
a worst link quality among the served UEs.

20. The apparatus of claim 18, wherein the configuration is indicative of a DMRS density pattern.

21. The apparatus of claim 18, wherein the at least one processor is configured to cause the UE to:
receive, from a network entity, via radio resource control (RRC) signaling or a system information block (SIB), a first indication of a DMRS density pattern from multiple candidate DMRS density patterns.

22. The apparatus of claim 21, wherein the at least one processor is configured to cause the UE to:
receive, from the network entity, via an RRC message, a second indication for the multiple candidate DMRS density patterns.

23. The apparatus of claim 18, wherein the at least one processor is configured to cause the UE to:
indicate, to a network entity, a capability for supporting the variable DMRS density pattern.

24. An apparatus for wireless communication at a network entity, comprising:
at least one memory; and
at least one processor coupled to the at least one memory and, based at least in part on information stored in the at least one memory, the at least one processor is configured to cause the network entity to:
transmit a configuration for a control resource set (CORESET); and
transmit, to a user equipment (UE), a physical downlink control channel (PDCCH) transmission in the CORESET spanning multiple symbols, wherein a first number of demodulation reference signal (DMRS) resource elements (REs) in a first symbol of the multiple symbols is higher than a second number of DMRS REs in any symbol of remaining symbols in the multiple symbols, wherein a DMRS density in the first symbol is based on one or more of a number of symbols in the multiple symbols or a minimum aggregation level for the DMRS REs.

25. The apparatus of claim 24, further comprising a transceiver coupled to the at least one processor, wherein to transmit the PDCCH transmission, the at least one processor is configured to cause the network entity to transmit the PDCCH transmission via the transceiver, wherein the DMRS density includes a ratio of a number of the DMRS REs to a total number of REs in a symbol, and wherein all the REs in the first symbol are the DMRS REs.

26. The apparatus of claim 25, wherein the remaining symbols do not include any DMRS RE.

27. The apparatus of claim 24, wherein the DMRS density in the first symbol is based on one or more of the number of symbols in the multiple symbols or the minimum aggregation level.

28. The apparatus of claim 24, wherein the at least one processor is configured to cause the network entity to:
allocate, in response to the number of symbols being less than or equal to a count threshold, all the DMRS REs to the first symbol, or
allocate, in response to the number of symbols being greater than the count threshold, at least one DMRS RE in the remaining symbols.

29. A method of wireless communication at a user equipment (UE), comprising:
receiving a configuration for a control resource set (CORESET); and
monitor for a physical downlink control channel (PDCCH) transmission in the CORESET spanning multiple symbols, wherein a first number of demodulation reference signal (DMRS) resource elements (REs) in a first symbol of the multiple symbols is higher than a second number of DMRS REs in any symbol of remaining symbols in the multiple symbols, wherein a DMRS density in the first symbol is based on one or more of a number of symbols in the multiple symbols or a minimum aggregation level for the DMRS REs.

30. A method of wireless communication at a network entity, comprising:
transmitting a configuration for a control resource set (CORESET); and
transmitting, to a user equipment (UE), a physical downlink control channel (PDCCH) transmission in the CORESET spanning multiple symbols, wherein a first number of demodulation reference signal (DMRS) resource elements (REs) in a first symbol of the multiple symbols is higher than a second number of DMRS REs in any symbol of remaining symbols in the multiple symbols, wherein a DMRS density in the first symbol is based on one or more of a number of symbols in the multiple symbols or a minimum aggregation level for the DMRS REs.
